(19) United States
(12) Patent Application Publication
(10) Pub. No.: US 2016/0307666 A1
(43) Pub. Date: Oct. 20, 2016

(54) HIGH-FREQUENCY WIRE AND COIL

(71) Applicant: FUJIKURA LTD., Tokyo (JP)

(72) Inventors: Chihiro KAMIDAKI, Sakura-shi (JP); Ning GUAN, Sakura-shi (JP); Takafumi MITSUNO, Sakura-shi (JP)

(73) Assignee: FUJIKURA LTD., Tokyo (JP)

(21) Appl. No.: 15/100,765

(22) PCT Filed: Oct. 24, 2014
(86) PCT No.: PCT/JP2014/078345

§ 371 Date: Jun. 1, 2016

(30) Foreign Application Priority Data
Dec. 2, 2013 (JP) 2013-249685

(51) Int. Cl. H01B 7/00; H01F 27/28

(52) U.S. Cl. CPC H01B 7/0009; H01F 27/2823

(57) ABSTRACT

A high-frequency wire includes: a conductor portion which includes an inner layer formed of a material having lower conductivity than copper, and an outer layer which coats the inner layer and is formed of copper. In a frequency range of an AC current for using the high-frequency wire, in a case where a skin thickness δ [m] of a copper wire including a conductor portion formed of pure copper is defined as δ=√(2/ωσμ), a thickness t [m] of the outer layer satisfies 1.1δ<t<2.7δ. Here ω indicates an angular frequency of a current, which is represented by 2πf, μ indicates magnetic permeability [H/m] of the copper wire, σ indicates conductivity [Ω⁻¹m⁻¹] of copper, and f indicates a frequency [Hz].

### TECHNICAL FIELD

The present invention relates to a high-frequency wire and a coil, for example, a high-frequency wire which is utilized in winding, a cable, and the like of various types of high-frequency equipment and a coil.

Priority is claimed on Japanese Patent Application No. 2013-249685, filed Dec. 2, 2013, the content of which is incorporated herein by reference.

### BACKGROUND ART

In winding and cables of equipment conducting AC currents, an eddy current is generated inside a conductor by a magnetic field generated by the AC current. As a result thereof, there are cases where AC resistance increases due to a skin effect or proximity effect, thereby causing heat generation or an increase of electricity consumption.

As countermeasures for suppressing occurrence of the skin effect and the proximity effect, the diameter of an element wire is reduced and a litz wire in which each element wire is subjected to insulation coating is employed (for example, refer to PTL 1 to PTL 3).

However, even when the litz wire is employed, suppression of the occurrence of the skin effect and the proximity effect by reducing the diameter of an element wire has a limit. In addition, solving a problem in that an increase of resistance is easily caused by the proximity effect at a high frequency is not possible.

As countermeasures for reducing the proximity effect or the skin effect, which focuses on an element wire, for example, a method in which the surface of a copper wire is coated with silver having electrical conductivity higher than that of copper is included. The abovementioned method uses concentration of a current on the surface of the copper wire due to the skin effect. A wire material of which reduction of resistance is achieved by coating with silver, or a cable using the wire material is commercially available in the market. However, the reduction countermeasures have a drawback in that the cost is high.

In PTL 5, a coil using an element wire formed from a material having lower electrical conductivity than that of copper is proposed as a coil in which AC resistance can be reduced more than that of a copper wire. However, the coil allows reduction of the proximity effect, but resistance is increased. Thus, application of the coil is limited only to a case where the proximity effect is large.

In PTL 4, NPL 1, and NPL 2, a structure in which the copper wire is formed so as to cause a magnetic layer to be coated with the copper wire, and thereby application of a magnetic field into the copper wire is suppressed and the proximity effect is reduced is proposed. However, in this structure, a current is concentrated on the magnetic layer, and thus there is a problem in that the skin effect is increased at a high frequency.

PTL 6 discloses a copper-coated aluminium wire. However, in the copper-coated aluminium wire, reduction of AC resistance is difficult in comparison to a copper wire having the same wire diameter as the copper-coated aluminium wire.

### PRIOR ART DOCUMENTS

### Patent Documents

[PTL 1] Japanese Unexamined Patent Application, First Publication No. 2009-129550
[PTL 2] Japanese Unexamined Patent Application, First Publication No. S62-76216
[PTL 3] Japanese Unexamined Patent Application, First Publication No. 2005-108654
[PTL 4] PCT International Publication No. WO2006/046358
[PTL 5] PCT International Publication No. WO2012/023378
[PTL 6] Japanese Unexamined Patent Application, First Publication No. 2003-147583

### Non-Patent Documents

[NPL 1] MIZONO Tsutomu, and 7 others, “Reduction in Eddy Current Loss in Conductor Using Magnetoplated Wire”, Journal A of The Institute of Electrical Engineering, 2007, Volume No. 127, No. 10, p. 611-620
[NPL 2] MIZONO Tsutomu, and 7 others, “Reduction of eddy current loss in magnetoplated wire”; The international Journal computation and mathematics in electrical and electronic engineering, 2009, Volume No. 28, No. 1, p. 57-66

### DISCLOSURE OF INVENTION

### Problem to be Solved by Invention

The present invention has been made in consideration of the above-referenced circumstances, and an object thereof is to provide a high-frequency wire and a coil in which the occurrence of the skin effect and the proximity effect can be suppressed and AC resistance can be reduced with low cost.

### Means for Solving the Problems

The present inventor completed the present invention focusing on the fact that a lower limit value and an upper limit value of a frequency region in which AC resistance Rac due to the skin effect and the proximity effect is smaller than AC resistance Rac of a copper wire are determined so as to be associated with the skin thickness δ of the copper wire, which is set as a reference. That is, the present invention includes the following configurations.

According to a first aspect of the present invention, a high-frequency wire including a conductor portion is provided. The conductor portion includes an inner layer formed of a material having lower conductivity than copper, and an outer layer which coats the inner layer and is formed of copper. In a frequency range of an AC current for using the high-frequency wire, in a case where a skin thickness δ [m] of a copper wire including a conductor portion formed of pure copper is defined as δ=√(2/ωσμ), a thickness t [m] of the outer layer satisfies 1.1δ<t<2.7δ. Here, ω indicates an angular frequency of a current, which is represented by 2πf, μ indicates magnetic permeability [H/m] of the copper wire, σ indicates conductivity [Ω⁻¹m⁻¹] of copper, and f indicates a frequency [Hz].

The thickness t of the outer layer may satisfy 1.3δ<t<2.7δ.

The thickness t of the outer layer may satisfy 2.0δ<t<2.7δ.

An insulation coating layer may be provided on an outer circumferential surface of the conductor portion.

According to a second aspect of the present invention, a high-frequency coil including the high-frequency wire according to the first aspect is provided.

According to a third aspect of the present invention, a litz wire including a plurality of the twisted high-frequency wires according to the first aspect is provided.

According to a fourth aspect of the present invention, a cable including the litz wire according to the third aspect, which is subjected to insulation coating, is provided.

According to a fifth aspect of the present invention, a coil including the litz wire according to the third aspect or the cable according to the fourth aspect is provided.

### Effects of the Invention

According to the aspects of the present invention, the thickness of the outer layer is in a predetermined range. Therefore, AC resistance thereof is lower than AC resistance of the copper wire. Accordingly, it is possible to improve a Q value of the coil.

### BRIEF DESCRIPTION OF DRAWINGS

FIG. 1 is a diagram illustrating a calculation example relating to resistance.

FIG. 2 is a diagram illustrating a calculation example relating to a proximity effect.

FIG. 3 is a diagram illustrating a calculation example relating to internal inductance.

FIG. 4 is a diagram illustrating a calculation example relating to the resistance.

FIG. 5 is a diagram illustrating a calculation example relating to the proximity effect.

FIG. 6 is a diagram illustrating a calculation example relating to the internal inductance.

FIG. 7A is a diagram illustrating a calculation example relating to the resistance, the proximity effect, and the internal inductance.

FIG. 7B is a diagram illustrating a calculation example relating to the resistance, the proximity effect, and the internal inductance.

FIG. 7C is a diagram illustrating a calculation example relating to the resistance, the proximity effect, and the internal inductance.

FIG. 8A is a diagram illustrating a calculation example relating to current density distribution.

FIG. 8B is a diagram illustrating a calculation example relating to current density distribution.

FIG. 8C is a diagram illustrating a calculation example relating to current density distribution.

FIG. 9A is a diagram illustrating a calculation example relating to eddy current density distribution.

FIG. 9B is a diagram illustrating a calculation example relating to eddy current density distribution.

FIG. 9C is a diagram illustrating a calculation example relating to eddy current density distribution.

FIG. 10A is a diagram illustrating a calculation example relating to a frequency region which causes resistance to be reduced in comparison to a copper wire.

FIG. 10B is a diagram illustrating a calculation example relating to a frequency region which causes the resistance to be reduced in comparison to the copper wire.

FIG. 10C is a diagram illustrating a calculation example relating to a frequency region which causes the resistance to be reduced in comparison to the copper wire.

FIG. 11A is a diagram illustrating a calculation example relating to a frequency region which causes the resistance and the proximity effect to be reduced in comparison to the copper wire.

FIG. 11B is a diagram illustrating a calculation example relating to a frequency region which causes the resistance and the proximity effect to be reduced in comparison to the copper wire.

FIG. 11C is a diagram illustrating a calculation example relating to a frequency region which causes the resistance and the proximity effect to be reduced in comparison to the copper wire.

FIG. 12A is a diagram illustrating a calculation example relating to a frequency region which causes the resistance and the proximity effect to be reduced in comparison to the copper wire, and causes internal inductance to be increased in comparison to the copper wire.

FIG. 12B is a diagram illustrating a calculation example relating to a frequency region which causes the resistance and the proximity effect to be reduced in comparison to the copper wire, and causes the internal inductance to be increased in comparison to the copper wire.

FIG. 12C is a diagram illustrating a calculation example relating to a frequency region which causes the resistance and the proximity effect to be reduced in comparison to the copper wire, and causes the internal inductance to be increased in comparison to the copper wire.

FIG. 13 is a diagram illustrating an analysis result.

FIG. 14 is a diagram illustrating an analysis result.

FIG. 15 is a diagram illustrating an analysis result.

FIG. 16A is a schematic diagram illustrating an analysis model of a high-frequency wire.

FIG. 16B is a schematic diagram illustrating an analysis model of the high-frequency wire.

FIG. 17 is a cross-sectional view illustrating a high-frequency wire according to an embodiment of the present invention.

FIG. 18 is a cross-sectional view illustrating a high-frequency wire including an insulation coating layer.

FIG. 19 is a perspective view illustrating an example of a litz wire.

FIG. 20 is a perspective view illustrating an example of a high-frequency coil.

FIG. 21 is a perspective view illustrating an example of a high-frequency coil.

FIG. 22 is a diagram illustrating a test result.

FIG. 23 is a diagram illustrating a test result.

### EMBODIMENTS FOR CARRYING OUT THE INVENTION

<Structure of Wire>

FIG. 17 is a cross-sectional view illustrating a high-frequency wire 10 (referred to as a wire 10 below) according to an embodiment of the present invention.

The wire 10 illustrated herein is a wire used for a specific frequency band. The wire 10 includes a conductor portion 11. The conductor portion 11 is formed from a two-layer structure conductor in which an inner layer 1 and an outer layer 2 are included. The outer layer 2 is formed so as to cause an outer circumferential surface of the inner layer 1 to be coated with the outer layer 2.

The inner layer 1 is formed of a material (material having volume resistivity higher than copper) which has lower conductivity than copper. As the material of the inner layer 1, metal having lower conductivity than copper may be used. The material of the inner layer 1 may be an insulating body. The material of the inner layer 1 may be a magnetic material or a non-magnetic material. The inner layer 1 may have a cross-section shape which is circular.

The cross-section in the embodiment is referred to as a surface perpendicular to an axis direction of the conductor portion 11.

As the material of the inner layer 1, specifically, for example, an aluminium-containing material, an iron-containing material, a nickel-containing material, and the like are appropriate.

The inner layer 1 is desirably formed of a homogeneous material. The inner layer 1 may be formed of a composite material which is formed from a plurality of materials. However, in this case, conductivity (also referred to as electrical conductivity) may be obtained based on a cross-sectional area ratio of the plurality of materials.

As the aluminium-containing material, aluminium (Al) and aluminium alloys may be used. For example, aluminium for an electric use (EC aluminium), Al—Mg—Si-based alloys (within JIS 6000 to 6999), and the like may be used.

A two-layer structure conductor in which the inner layer is formed from an aluminium wire, and the outer layer is formed from copper is referred to as a copper-coating aluminium wire.

As the iron-containing material, iron (Fe) and iron alloys may be used. An example of the iron alloys includes a material containing one or more substances among carbon, silicon, nickel, tungsten, and chromium. For example, a steel wire, a stainless steel wire, or the like may be appropriately used as the inner layer 1.

A two-layer structure conductor in which the inner layer is formed from a steel wire, and the outer layer is formed from copper is referred to as a copper-coating steel wire.

As the nickel-containing material, nickel, nickel alloys, and the like may be used.

As the nickel alloys, a nickel-chromium alloy is exemplified. In this case, for example, a nichrome wire may be used as the inner layer 10.

A two-layer structure conductor in which the inner layer is formed from a nichrome wire, and the outer layer is formed from copper is referred to as a copper-coating nichrome wire.

The inner layer 1 is not limited to the exemplified materials. Pure metal such as magnesium, tungsten, titanium, and iron may be used for the inner layer 1. Copper alloys such as brass, phosphor bronze, silicon bronze, copper•beryllium alloys, and copper•nickel•silicon alloys may be used. In addition, an insulating body such as rubber and plastic may be used.

The outer layer 2 is formed of copper. It is desirable that the cross-section area of the outer layer 2 be equal to or less than 50% with respect to the cross-section area of the entirety of the conductor portion 11 obtained by combining the inner layer 1 and the outer layer 2. Such a cross-sectional area ratio (cross-sectional area ratio of the outer layer 2 to the cross-section area of the entirety of the conductor portion 11) may be set to be 5% to 50%, for example. The cross-sectional area ratio of the outer layer 2 is set to be in the above range, and thus the cross-sectional area ratio of the outer layer 2 contributes to reduction of AC resistance.

The outer layer 2 may have a constant thickness.

The diameter of the entirety of the wire 10 (diameter of the conductor portion 11) may be set to be 0.05 mm to 3.2 mm, for example.

In the high-frequency wire according to the embodiment, in addition to the inner layer and the outer layer, one or more insulating layers of resin, ethylene, or the like may be formed on an outer circumferential side of the outer layer.

Next, in order to describe a skin effect, electricity consumption in a case where an AC current is applied to the two-layer structure conductor is analyzed.

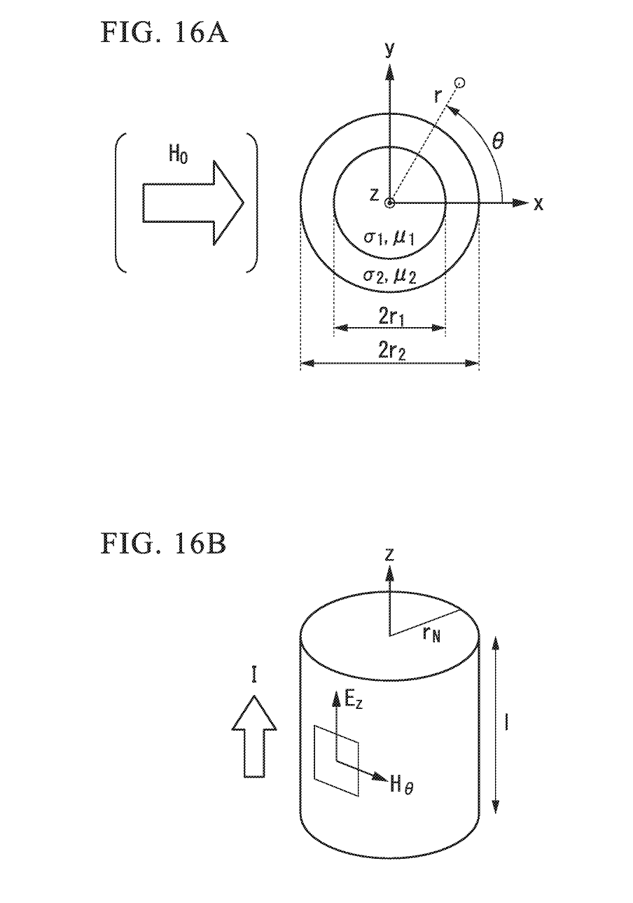

As illustrated in FIG. 16A, a two-layer structure conductor is modeled. In the two-layer structure conductor, the cross-section is circular, and layers are configured from materials different from each other, and are uniformly extended in a z-axis direction. An outer diameter of the i-th layer from the inside of the two-layer structure conductor is set as 2rᵢ, conductivity thereof is set as σᵢ, and relative magnetic permeability thereof is set as μᵢ. A time factor is set as e^{jωt}. μ₀ indicates magnetic permeability in a vacuum. i is a natural number. j indicates an imaginary unit, and ω indicates an angular frequency defined as ω=2πf when f is set to indicate a frequency.

As illustrated in FIG. 16B, when a current having amplitude of I flows in a z-axis direction of the lead wire, a z component E_{z} of an electric field satisfies the following wave equation.

$$\frac{{\partial }^{2} {E}_{z}}{\partial {r}^{2 }} + \frac{1}{r} \frac{\partial {E}_{z}}{\partial r} - j ω {μ}_{i} {μ}_{0} {σ}_{i} {E}_{z} = 0 \qquad ( 1 )$$

Since Expression (1) is the 0-th order Bessel equation, Expression (1) has the following solution.

$${E}_{z} = \{ \begin{matrix}{A}_{1} {J}_{0} ( {k}_{1} r ) & ( r \leq {r}_{1} ) \\ {A}_{2} {J}_{0} ( {k}_{2} r ) + {B}_{2} {Y}_{0} ( {k}_{2} r ) & ( {r}_{1} < r \leq {r}_{2} )\end{matrix} \qquad ( 2 )$$

kᵢ² is represented by the following expression.

kᵢ²=−jωμ₀μᵢσᵢ

Jₙ and Yₙ are respectively set to be the n-th order Bessel function and the n-th order Neumann function. Aᵢ and Bᵢ are constants determined by the following boundary conditions.

$${{{E}_{z} {\vert}_{r = ri -} = {E}_{z} {\vert}_{r = ri +} \\ \frac{1}{{μ}_{i}} \frac{\partial {E}_{z}}{\partial r} \vert}_{r = ri -} = \frac{1}{{μ}_{i + 1 }} \frac{\partial {E}_{z}}{\partial r} \vert}_{r = ri +}$$

A magnetic field is represented by the following expression, based on the Maxwell equation. The magnetic field H_{θ} indicates a component of a θ direction.

$${H}_{θ} = \{ \begin{matrix}- \frac{{σ}_{1}}{{k}_{1}} {A}_{1} {J}_{0} ( {k}_{1} r ) & ( r \leq {r}_{1} ) \\ - \frac{{σ}_{2}}{{k}_{2}} [ {A}_{2} {J}_{0} ( {k}_{2} r ) + {B}_{2} {Y}_{0} ( {k}_{2} r ) ] & ( {r}_{1} < r \leq {r}_{2} )\end{matrix} \qquad ( 3 )$$

A time average of electricity consumption of the lead wire having a length l is equal to a value obtained by integrating a pointing vector flowing from the surface of the lead wire, with the surface S of the lead wire. Thus, the time average is represented as follows.

$$\begin{matrix}{\overline{P}}_{s} = - \frac{1}{2} ∮ E \times {H}^{*} \cdot d S \\ = \frac{j ω {μ}_{N} {μ}_{0} l {\vert I \vert}^{2}}{4 π ξ} \cdot \frac{{A}_{N} {J}_{0} ( ξ ) + {B}_{N} {Y}_{0} ( ξ )}{{A}_{N} {J}_{0}^{′} ( ξ ) + {B}_{N} {Y}_{0}^{′} ( ξ )} \\ = \frac{1}{2} {\vert I \vert}^{2} ( {R}_{s} + j ω {L}_{i} ) l\end{matrix} \qquad ( 4 )$$

(P̅ₛ: time average Lᵢ:internal inductance of unit length of conductor)

ζ is indicated by ζ=k₂r₂.

Resistance Rₛ and internal inductance Lᵢ when an AC current is applied to the two-layer structure conductor having a unit length are represented by the following expression.

It is desirable that the frequency of the AC current be a frequency in a specific frequency region which is defined (set) as a range in which the wire (product) is used.

$${R}_{s} = Re [ \frac{j ω {μ}_{2} {μ}_{0}}{2 π ξ} \frac{{A}_{2} {J}_{0} ( ξ ) + {B}_{2} {Y}_{0} ( ξ )}{{A}_{2} {J}_{0}^{′} ( ξ ) + {B}_{2} {Y}_{0}^{′} ( ξ )} ] \\ {L}_{i} = Im [ \frac{j {μ}_{2} {μ}_{0}}{2 π ξ} \frac{{A}_{2} {J}_{0} ( ξ ) + {B}_{2} {Y}_{0} ( ξ )}{{A}_{2} {J}_{0}^{′} ( ξ ) + {B}_{2} {Y}_{0}^{′} ( ξ )} ] \qquad ( 5 )$$

When σ₁=σ₂ and μ₁=μ₂, A₂=1 and B₂=0 are set and Rₛ in Expression (5) is represented by the following expression.

$${R}_{s} = Re [ \frac{j {ωμ}_{2} {μ}_{0}}{2 π ξ} \frac{{J}_{0} ( ξ )}{{J}_{0}^{′} ( ξ )} ] \qquad ( 6 )$$

The layers are magnetic substances. In a case where magnetic loss is indicated by magnetic hysteresis and the like, the loss may be indicated by introducing an imaginary part into magnetic permeability. For example, the following expression is established.

μ₁=μ₁ᵣ+μ₁ᵢ (7)

Next, in order to describe a proximity effect, electricity consumption in a case where an AC magnetic field is uniformly applied to the two-layer structure conductor from the outside is analyzed.

As illustrated in FIG. 16A, if a vector potential satisfying H=∇×A is introduced, the vector potential A₂=H₀r sin θ in the z-axis direction is applied to a magnetic field having uniform amplitude H₀ from an x-axis direction.

When the magnetic field is caused to react with the lead wire, A_{z} satisfies the following wave equation.

$$\frac{{\partial }^{2} {A}_{z}}{\partial {r}^{2}} + \frac{1}{r} \frac{\partial {A}_{z}}{\partial r} + \frac{1}{r} \frac{{\partial }^{2} {A}_{z}}{\partial {θ}^{2}} + {k}_{2}^{2} {A}_{z} = 0 \qquad ( 8 )$$

Expression (8) has the following solution.

$${A}_{z} = sin θ \times \{ \begin{matrix}{C}_{1} {J}_{1} ( {k}_{1} r ) & ( r \leq {r}_{1} ) \\ {C}_{2} {J}_{1} ( {k}_{2} r ) + {D}_{2} {Y}_{1} ( {k}_{2} r ) & ( {r}_{1} < r \leq {r}_{2} ) \\ {C}_{3} r + {D}_{3} {r}^{- 1} & ( {r}_{2} \leq r )\end{matrix} \qquad ( 9 )$$

Cᵢ and Dᵢ are constants determined by the following boundary conditions.

$${{{μ}_{i} {A}_{z} {\vert}_{r = ri -} = {μ}_{i + 1} {A}_{z} {\vert}_{r = ri +} \\ \frac{\partial {A}_{z}}{\partial r} \vert}_{r = ri -} = \frac{\partial {A}_{z}}{\partial r} \vert}_{r = ri +}$$

The magnetic field and the electric field are represented by the following expression by using Expression (9).

$$\begin{matrix}{H}_{θ} = \{ \begin{matrix}- {k}_{1} [ {C}_{1} {J}_{1}^{′} ( {k}_{1} r ) ] sin θ & ( r \leq {r}_{1} ) \\ - {k}_{2} [ {C}_{2} {J}_{1}^{′} ( {k}_{2} r ) + {D}_{2} {Y}_{1}^{′} ( {k}_{2} r ) ] sin θ & ( {r}_{1} < r \leq {r}_{2} ) \\ [ {C}_{3} - \frac{{D}_{3}}{{r}^{2}} ] sin θ & ( {r}_{2} < {r}_{2} )\end{matrix} & ( 10 ) \\ {E}_{z} = \{ \begin{matrix}\frac{{k}_{1}^{2}}{{σ}_{1 }} [ {C}_{1} {J}_{1}^{′} ( {k}_{1} r ) ] sin θ & ( r \leq {r}_{1} ) \\ \frac{{k}_{2}^{2}}{{σ}_{1 }} [ {C}_{2} {J}_{1}^{′} ( {k}_{2} r ) + {D}_{2} {Y}_{1}^{′} ( {k}_{2} r ) ] sin θ & ( {r}_{1} < r \leq {r}_{2} ) \\ \frac{{D}_{3}}{j ω {μ}_{0} {r}^{3}} sin θ & ( {r}_{2} < {r}_{2} )\end{matrix} & ( 11 )\end{matrix}$$

At this time, since electricity consumption in the lead wire is equal to a real part of a value obtained by integrating a pointing vector flowing from the surface of the lead wire, with the surface S of the lead wire, when the magnetic field having amplitude H₀ is caused to react, the time average of eddy current loss occurring in the lead wire having a length l is represented by the following expression.

$$\begin{matrix}\begin{matrix}{\overline{P}}_{p} = - \frac{1}{2} ∮ E \times {H}^{*} \cdot d S \\ = - \frac{2 π l {\vert ξ \vert}^{2} {\vert {H}_{0} \vert}^{2}}{{σ}_{N}} \frac{ξ {XY}^{*}}{λ {\vert Z \vert}^{2 }} \\ = \frac{1}{2} {\vert I \vert}^{2} ( {R}_{p} + j ω {L}_{m} ) l\end{matrix} & ( 12 ) \\ X = {C}_{2} {J}_{1} ( ξ ) + {D}_{2} {Y}_{1} ( ξ ) \\ Y = {C}_{2} {J}_{1}^{′} ( ξ ) + {D}_{2} {Y}_{1}^{′} ( ξ ) \\ Z = ( {μ}_{2} - 1 ) X + ξ [ {C}_{2} {J}_{0} ( ξ ) + {D}_{2} {Y}_{0} ( ξ ) ] & \end{matrix}$$

(P̅ₚ:time average Lₘ:mutual internal inductance of unit length of conductor)

Since a near magnetic field of a coil is generated by a current I flowing in the coil, the amplitude H₀ of the magnetic field is proportional to the amplitude of I. If the proportional coefficient is set as α, H₀ is represented as follows.

|H₀|=α|I| (13)

Thus, resistance Rₚ by the proximity effect is represented as follows.

Rₚ=α²Dₚ (14)

Dₚ is represented as follows.

$${D}_{p} = - \frac{4 π {\vert ξ \vert}^{2}}{{σ}_{2 }} Re [ \frac{ξ {XY}^{*}}{{\vert Z \vert}^{2}} ] \qquad ( 15 )$$

When σ₁=σ₂ and μ₁=μ₂ are set, C₂=1 and D₂=0 are set, and Expression (15) is represented by the following expression.

$${D}_{p} = - \frac{4 π}{{σ}_{2 }} Re [ \frac{ξ {J}_{1} ( ξ ) {J}_{1}^{′} ( ξ )}{{\vert {J}_{0} ( ξ ) \vert}^{2}} ] \qquad ( 16 )$$

AC resistance R_{ac} of the coil or the cable is represented as the sum of resistance Rₛ by electrification and resistance Rₚ by the proximity effect.

R_{ac}=Rₛ+Rₚ (17)

In this manner, Rₛ and Dₚ are formulated, and thus a lead wire which is a two-layer structure conductor of which the outer layer is configured by copper, and a lead wire (copper wire) formed from copper are compared to each other regarding the skin effect and the proximity effect.

### EXAMPLES

### Examples 1 to 3, Comparative Example 1

Regarding a two-layer structure conductor (copper-coating aluminium wire (Example 1), a two-layer structure conductor (copper-coating steel wire) (Example 2), and a two-layer structure conductor (copper-coating nichrome wire) (Example 3), the following calculation was performed. In the copper-coating aluminium wire (Example 1), the inner layer was formed by an alloy aluminium wire, and the outer layer was formed by copper. In the copper-coating steel wire (Example 2), the inner layer was formed by a steel wire and the outer layer was formed by copper. In the copper-coating nichrome wire (Example 3), the inner layer was formed by a nickel wire, and the outer layer was formed by copper.

For comparison, similar calculation was performed on a copper wire having a single-layer structure (one-layer structure) (Comparative Example 1). The copper wire may have a cross-section which is circular. The single-layer structure is referred to as a structure formed from a homogeneous material.

In the following descriptions, the two-layer structure conductor or the copper wire may be singly referred to as a “lead wire”. In addition, alloy aluminium may be singly referred to as “aluminium”.

The outer diameter of the lead wires (Examples 1 to 3 and Comparative Example 1) was set to 1.0 mm. In Examples 1 to 3 (two-layer structure conductors), the cross-sectional area ratio of the outer layer to the entirety of the lead wire was set to 25%.

Regarding the two-layer structure conductors in Examples 1 to 3 and Comparative Example 1, resistance Rₛ and internal inductance Lᵢ shown in the abovementioned Expression (5) were obtained by calculation. Dₚ shown in the abovementioned Expression (15) was obtained by calculation.

With the calculation, volume resistivity (20° C.) of copper was set to 1.72×10⁻⁸ [Ω·m], volume resistivity (20° C.) of alloy aluminium was set to 3.02×10⁻⁸ [Ω·m], volume resistivity (20° C.) of steel was set to 1.57×10⁻⁷ [Ω·m], and volume resistivity (20° C.) of nichrome was set to 1.50×10⁻⁶ [Ω·m]. The volume resistivity of alloy aluminium referred to an I-aluminium alloy wire (JEC-3405, standard of Electrical Standards Committee in Institute of Electrical Engineering). The conductivity (20° C.) of copper was set to 5.8×10⁷ [Ω⁻¹·m⁻¹], the conductivity (20° C.) of alloy aluminium was set to 3.3×10⁷ [Ω⁻¹·m⁻¹], the conductivity (20° C.) of steel was set to 6.4×10⁶ [Ω⁻¹·m⁻¹], and the conductivity (20° C.) of nichrome was set to 6.6×10⁶ [Ω⁻¹·m⁻¹].

Relative magnetic permeability of copper was set to 1, the relative magnetic permeability of alloy aluminium was set to 1, the relative magnetic permeability of steel was set to 100, and the relative magnetic permeability of nichrome was set to 1.

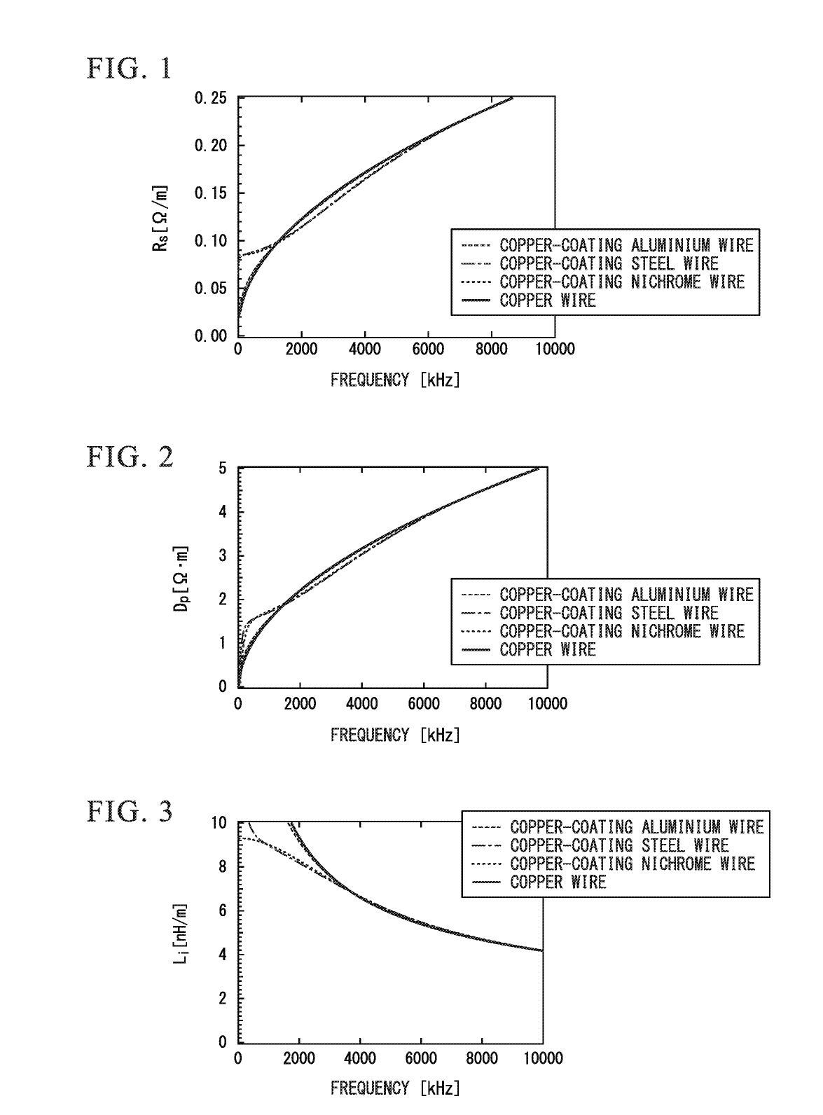

FIG. 1 illustrates a calculation result of the resistance Rₛ. The resistance Rₛ in Examples 1 to 3 (two-layer structure conductors) was lower than that in Comparative Example 1 (copper wire), in a range in which a frequency was higher than a first frequency (about 1.2 MHz) and less than a second frequency (about 7.1 MHz) which was higher than the first frequency.

That is, the resistance Rₛ in Examples 1 to 3 (two-layer structure conductors) was higher than the resistance Rₛ in Comparative Example 1 (copper wire) on a lower frequency side than the first frequency. The resistance Rₛ in Examples 1 to 3 and the resistance Rₛ in Comparative Example 1 matched each other at the first frequency. The resistance Rₛ in Examples 1 to 3 was lower than the resistance Rₛ in Comparative Example 1, in a range in which a frequency was on a higher frequency side than the first frequency and was less than the second frequency. The resistance Rₛ in Examples 1 to 3 and the resistance Rₛ in Comparative Example 1 matched each other again at the second frequency. The resistance Rₛ in Examples 1 to 3 was higher than the resistance Rₛ in Comparative Example 1, on a higher frequency side than the second frequency.

FIG. 2 illustrates a calculation result of Dₚ. Dₚ in Examples 1 to 3 (two-layer structure conductors) was lower than Dₚ in Comparative Example 1 (copper wire), in a range in which a frequency was higher than a first frequency (about 1.5 MHz) and less than a second frequency (about 7.1 MHz) which was higher than the first frequency.

That is, Dₚ in Examples 1 to 3 (two-layer structure conductors) was higher than Dₚ in Comparative Example 1 (copper wire) on a lower frequency side than the first frequency. Dₚ in Examples 1 to 3 and Dₚ in Comparative Example 1 matched each other at the first frequency. Dₚ in Examples 1 to 3 was lower than Dₚ in Comparative Example 1, in a range in which a frequency was on a higher frequency side than the first frequency and was less than the second frequency. Dₚ in Examples 1 to 3 and Dₚ in Comparative Example 1 matched each other again at the second frequency. Dₚ in Examples 1 to 3 was higher than Dₚ in Comparative Example 1, on a higher frequency side than the second frequency.

FIG. 3 illustrates a calculation result of the internal inductance Lᵢ. Lᵢ in Examples 1 to 3 (two-layer structure conductors) was higher than Lᵢ in Comparative Example 1 (copper wire), in a range in which a frequency was on a higher frequency than a first frequency (about 3.6 MHz) and less than a second frequency (about 10 MHz) which was higher than the first frequency.

That is, the internal inductance Lᵢ in Examples 1 to 3 (two-layer structure conductors) was lower than Lᵢ in Comparative Example 1 (copper wire) on a lower frequency side than the first frequency. Lᵢ in Examples 1 to 3 and Lᵢ in Comparative Example 1 matched each other at the first frequency. Lᵢ in Examples 1 to 3 was higher than Lᵢ in Comparative Example 1, in a range in which a frequency was on the higher frequency side than the first frequency and was less than the second frequency. Lᵢ in Examples 1 to 3 and Lᵢ in Comparative Example 1 matched each other again at the second frequency. Lᵢ in Examples 1 to 3 was lower than Lᵢ in Comparative Example 1, on a higher frequency side than the second frequency.

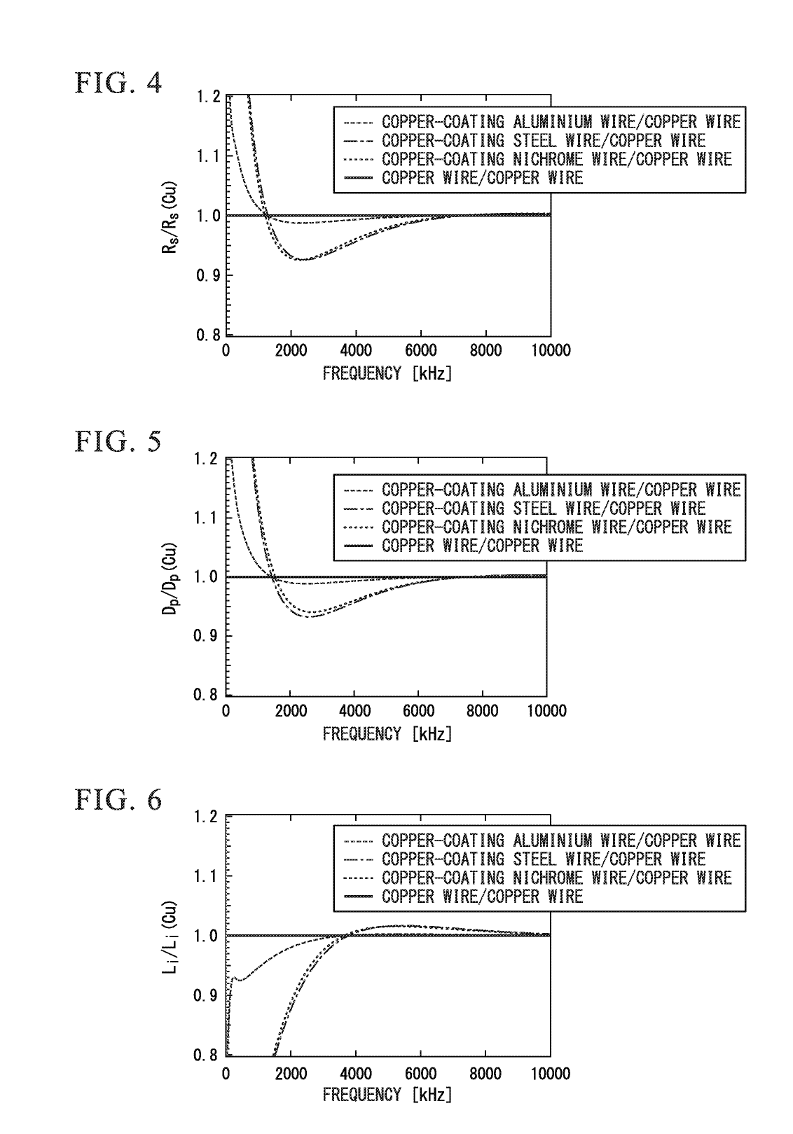

FIG. 4 is a diagram illustrating a ratio (Examples 1 to 3/Comparative Example 1) of the resistance Rₛ between Examples 1 to 3 and Comparative Example 1 (copper wire), for easy understanding of the calculation result illustrated in FIG. 1. The following are understood based on FIG. 4.

In Example 1 (copper-coating aluminium wire), the resistance Rₛ could be reduced by about 1%, which was the maximum, in comparison to Comparative Example 1 (copper wire).

In Example 2 (copper-coating steel wire), the resistance Rₛ could be reduced by approximately 7%, which was the maximum, in comparison to Comparative Example 1 (copper wire).

In Example 3 (copper-coating nichrome wire), the resistance Rₛ could be reduced by approximately 7%, which was the maximum, in comparison to Comparative Example 1 (copper wire).

FIG. 5 is a diagram illustrating a ratio (Examples 1 to 3/Comparative Example 1) of Dₚ between Examples 1 to 3 and Comparative Example 1 (copper wire), for easy understanding of the calculation result illustrated in FIG. 2. The following are understood based on FIG. 5.

In Example 1 (copper-coating aluminium wire), Dₚ could be reduced by about 1%, which was the maximum, in comparison to Comparative Example 1 (copper wire).

In Example 2 (copper-coating steel wire), Dₚ could be reduced by approximately 7%, which was the maximum, in comparison to Comparative Example 1 (copper wire).

In Example 3 (copper-coating nichrome wire), Dₚ could be reduced by approximately 7%, which was the maximum, in comparison to Comparative Example 1 (copper wire).

FIG. 6 is a diagram illustrating a ratio (Examples 1 to 3/Comparative Example 1) of the internal inductance Lᵢ between Examples 1 to 3 and Comparative Example 1 (copper wire), for easy understanding of the calculation result illustrated in FIG. 3. The following are understood based on FIG. 6.

In Example 1 (copper-coating aluminium wire), the internal inductance Lᵢ could be increased by approximately 0.3%, which was the maximum, in comparison to Comparative Example 1 (copper wire).

In Example 2 (copper-coating steel wire), the internal inductance Lᵢ could be increased by approximately 2%, which was the maximum, in comparison to Comparative Example 1 (copper wire).

In Example 3 (copper-coating steel wire), the internal inductance Lᵢ could be increased by approximately 2%, which was the maximum, in comparison to Comparative Example 1 (copper wire).

### Example 4

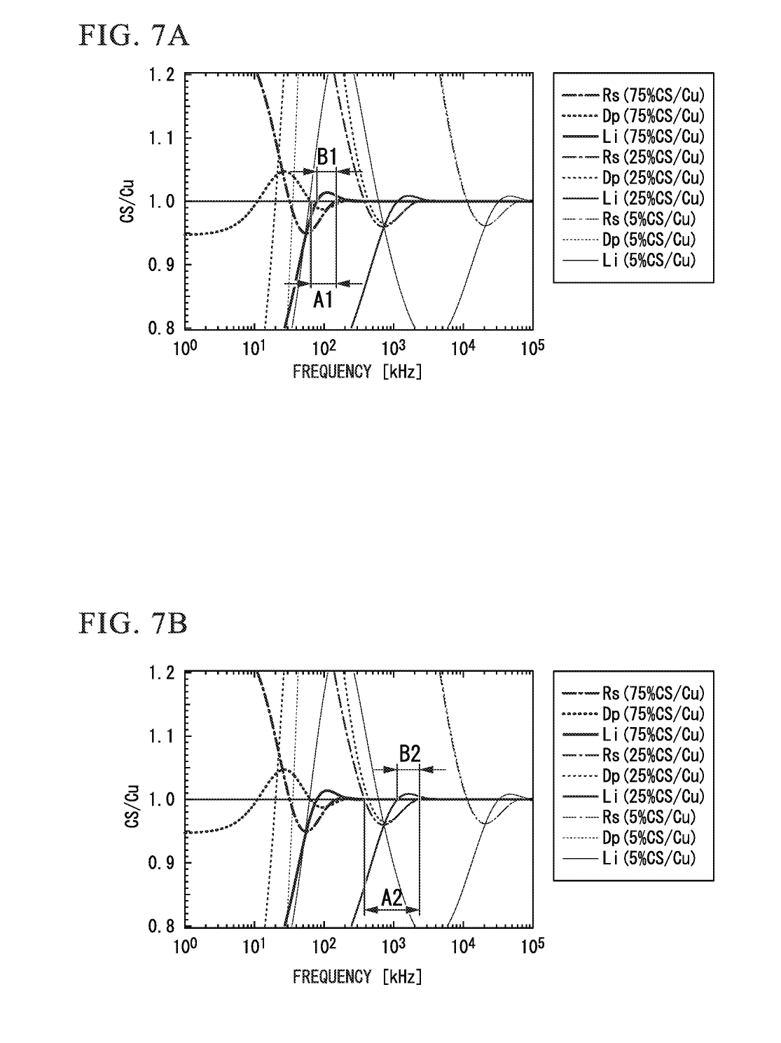

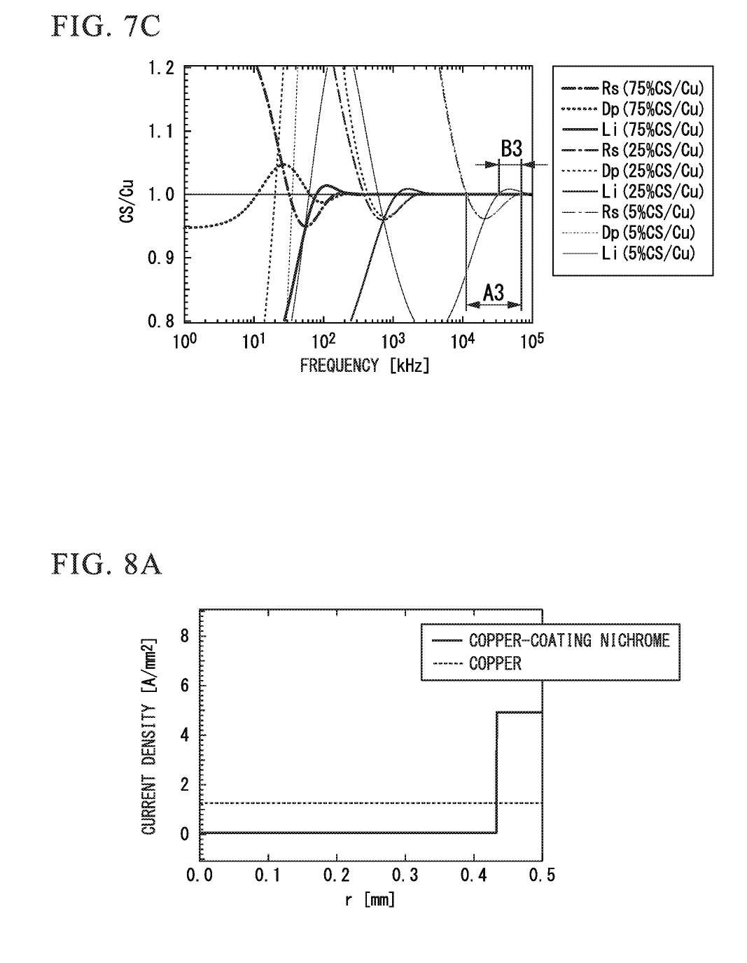

A two-layer structure conductor (copper-coating steel wire) was similar to that in Example 2 except that the cross-sectional area ratio of the outer layer was set to 75%. Regarding the two-layer structure conductor (copper-coating steel wire), the ratio of Rₛ, the ratio of Dₚ, and the ratio of Lᵢ to Rₛ, Dₚ, and Lᵢ in Comparative Example 1 (copper wire) were obtained. FIG. 7A illustrates a result.

In FIG. 7A, the ratio of Rₛ to Rₛ in Comparative Example 1 (copper wire) was marked as “Rₛ (75% CS/Cu)”, the ratio of Dₚ to Dₚ in Comparative Example 1 (copper wire) was marked as “Dₚ (75% CS/Cu)”, and the ratio of Lᵢ to Lᵢ in Comparative Example 1 (copper wire) was marked as (“Lᵢ (75% CS/Cu)”.

Regarding Example 2, the ratio of Rₛ, the ratio of Dₚ, and the ratio of Lᵢ to Rₛ, Dₚ, and Lᵢ in Comparative Example 1 (copper wire) were also obtained. FIG. 7A illustrates a result.

In FIG. 7A, the ratio of Rₛ to Rₛ in Comparative Example 1 (copper wire) was marked as “Rₛ (25% CS/Cu)”, the ratio of Dₚ to Dₚ in Comparative Example 1 (copper wire) was marked as “Dₚ (25% CS/Cu)”, and the ratio of Lᵢ to Lᵢ in in Comparative Example 1 (copper wire) was marked as “Lᵢ (25% CS/Cu)”.

### Example 5

A two-layer structure conductor (copper-coating steel wire) was similar to that in Example 2 except that the cross-sectional area ratio of the outer layer was set to 5%. Regarding the two-layer structure conductor (copper-coating steel wire), the ratio of Rₛ, the ratio of Dₚ, and the ratio of Lᵢ to Rₛ, Dₚ, and Lᵢ in Comparative Example 1 (copper wire) were obtained. FIG. 7A illustrates a result.

In FIG. 7A, the ratio of Rₛ to Rₛ in Comparative Example 1 (copper wire) was marked as “Rₛ (5% CS/Cu)”, the ratio of Dₚ to Dₚ in Comparative Example 1 (copper wire) was marked as “Dₚ (5% CS/Cu)”, and the ratio of Lᵢ to Lᵢ in Comparative Example 1 (copper wire) was marked as “Lᵢ (5% CS/Cu)”.

As illustrated in FIG. 7A, Rₛ in Example 4 (copper-coating steel wire) is smaller than Rₛ in Comparative Example 1 (copper wire), in a frequency region A1. For this reason, Example 4 has an advantage of Rₛ over Comparative Example 1 in the frequency region A1.

Since Dₚ in Example 4 is smaller than Dₚ in Comparative Example 1 in the frequency region A1, Example 4 has an advantage of Dₚ over Comparative Example 1 in the frequency region A1.

In a frequency region B1, which is a region in the frequency region A1 and is narrower than the frequency region A1, since Lᵢ in Example 4 is greater than Lᵢ in Comparative Example 1, Example 4 has an advantage of Lᵢ over Comparative Example 1 in the frequency region A1.

As described above, Example 4 has advantages of Rₛ and Dₚ in the frequency region A1, and also has an advantage of Lᵢ in the frequency region B1, which is narrower than the region A1.

As illustrated in FIG. 7B, Example 2 has advantages of Rₛ and Dₚ in a frequency region A2, and also has an advantage of Lᵢ in a frequency region B2, which is narrower than the region A2.

As illustrated in FIG. 7C, Example 5 has advantages of Rₛ and Dₚ in a frequency region A3, and also has an advantage of Lᵢ in a frequency region B3, which is narrower than the region A3.

The result of Rₛ, Dₚ, and Lᵢ may be considered as follows.

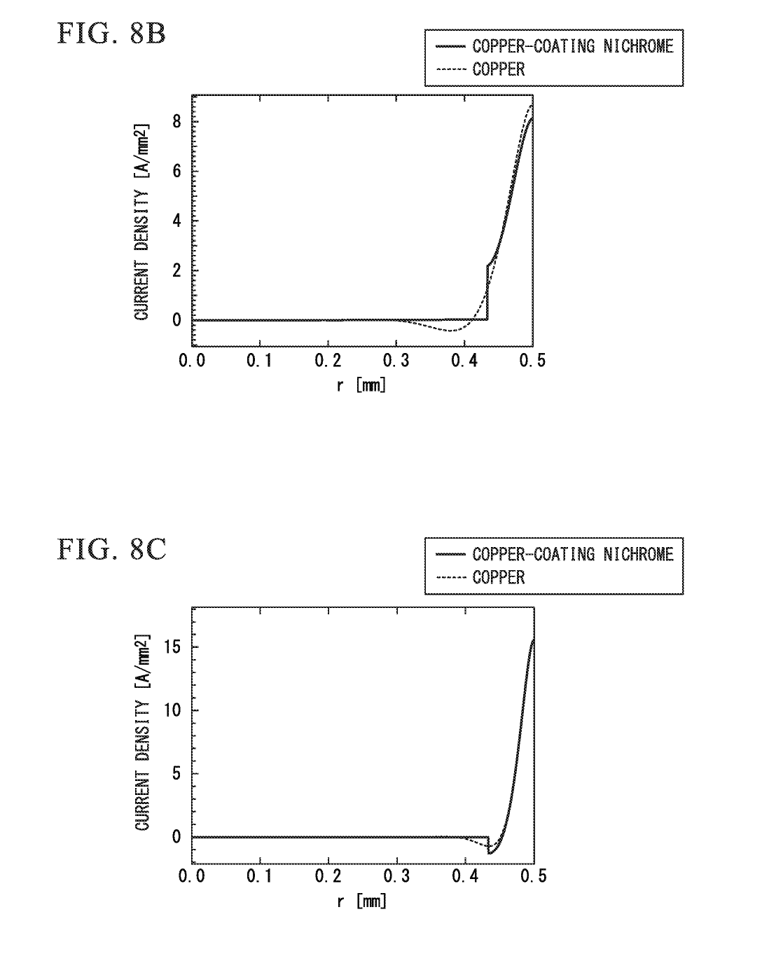

FIGS. 8A to 8C are diagrams illustrating a real part of current density distribution in a radial direction of a copper-coating nichrome wire when a current having a frequency of 1 kHz (FIG. 8A), 3 MHz (FIG. 8B), or 10 MHz (FIG. 8C) flows into the copper-coating nichrome wire (Example 3, cross-sectional area ratio of outer layer: 25%, outer diameter: 1.0 mm).

The current density distribution for Comparative Example 1 (copper wire) was similarly calculated.

The current density distribution was calculated by multiplying conductivity by Expression (2).

In FIG. 8A, the current uniformly flows in a positive direction, at 1 kHz, and most of the current flows only into the outer layer (copper) of the copper-coating nichrome wire. For this reason, it is understood that the effective cross-section area in which the current flows in the copper-coating nichrome wire is smaller than that in the copper wire, and the current distribution has large deviation.

Since the loss has a square function of a current, the loss is increased as the deviation of the current distribution becomes larger. For this reason, the copper-coating nichrome wire has larger resistance than the copper wire.

In FIG. 8B, it is understood that a portion of the current flowing the copper wire flows into the inside thereof in a negative direction (that is, reflux is caused) at 3 MHz, but, in the copper-coating nichrome wire, the reflux is not caused.

Since the reflux is caused in the copper wire, the current in the positive direction is largely deviated, and thus the resistance is larger than that of the copper-coating nichrome wire.

In FIG. 8C, the reflux is also caused in the outer layer of a copper-nichrome wire, at 10 MHz. The current density distribution of the copper-nichrome wire is approximate to the current density distribution of the copper wire.

It is understood that the reflux is caused in the copper wire in a frequency region including 3 MHz, and the current is concentrated on a portion corresponding to the outer layer, and thus the loss in the copper-nichrome wire is smaller than the loss in the copper wire, based on the results.

As described above, in the two-layer structure conductor in which the inner layer is formed from a material having lower conductivity than copper, and the outer layer is formed from copper, it is possible to suppress an increase of resistance in a specific frequency region, in comparison to that of the copper wire. Accordingly, it is possible to improve the Q value of a coil.

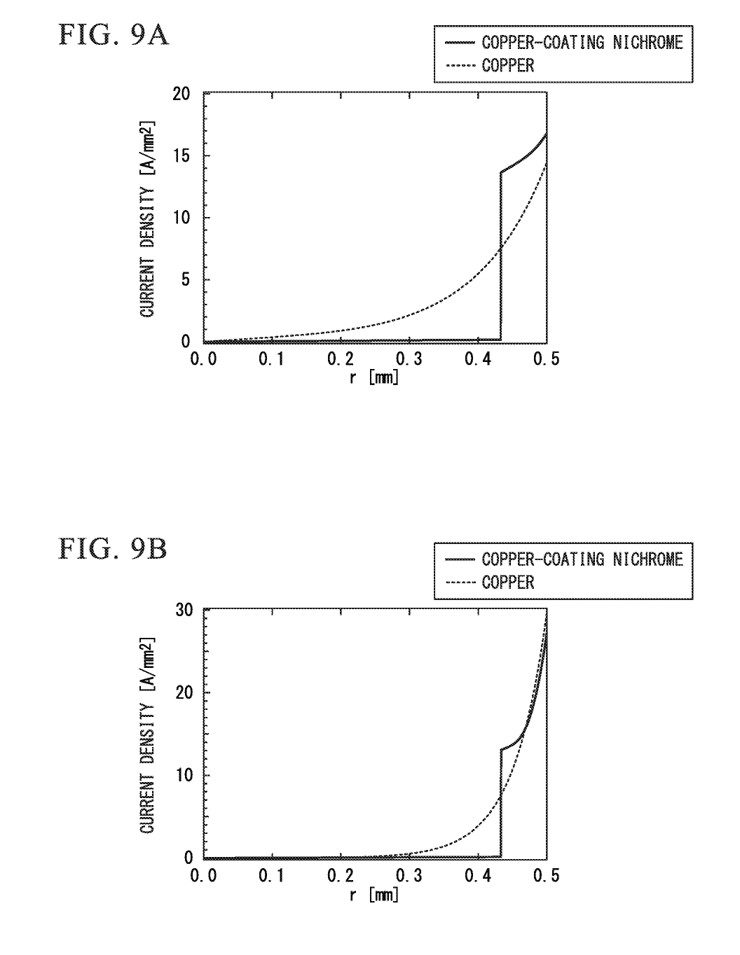

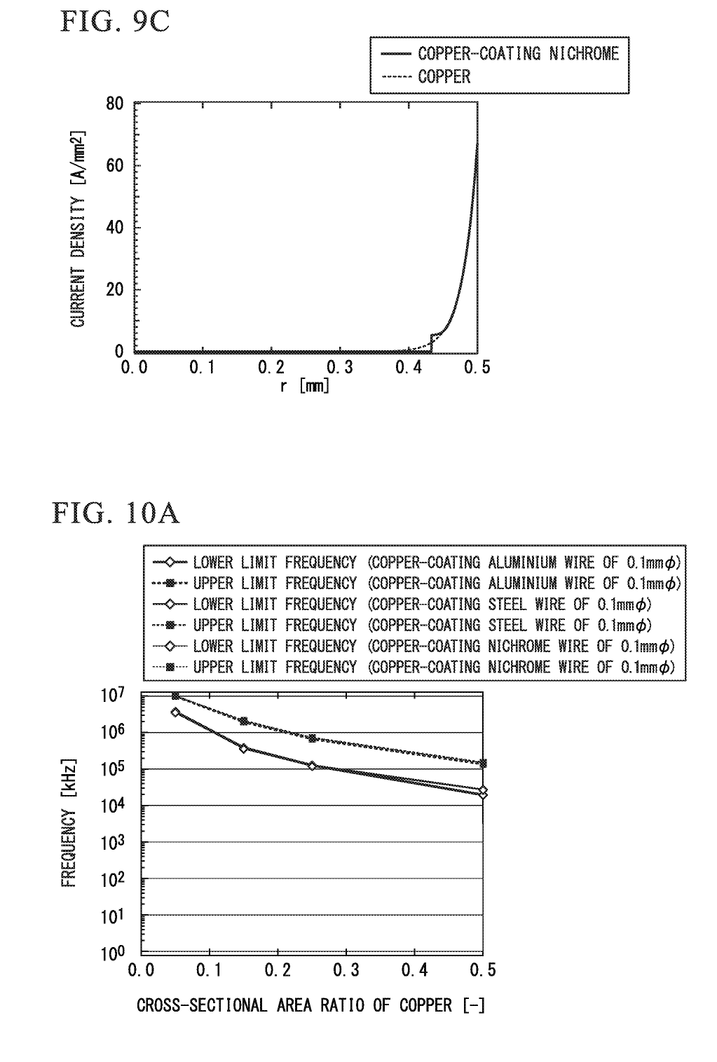

FIGS. 9A to 9C are diagrams illustrating an absolute value of eddy current density on a surface which is perpendicular to an external magnetic field and passes through the center of a lead wire (copper-coating nichrome wire) when a uniform magnetic field is applied to the copper-coating nichrome wire (Example 3, cross-sectional area ratio of outer layer: 25%, outer diameter: 1.0 mm) from the outside thereof.

FIG. 9A illustrates an absolute value of eddy current density in a case where the frequency of the magnetic field is 500 kHz. FIG. 9B illustrates an absolute value of eddy current density in a case where the frequency of the magnetic field is 2 MHz. FIG. 9C illustrates an absolute value of eddy current density in a case where the frequency of the magnetic field is 10 MHz.

The absolute value of the eddy current density for Comparative Example 1 (copper wire) was similarly calculated.

The current density distribution was calculated by multiplying conductivity by Expression (11).

In FIG. 9A, it is understood that an eddy current in the copper-coating nichrome wire flows into the outer layer at 500 kHz, and thus the current density distribution in the copper-coating nichrome wire is deviated larger than that of the copper wire.

In FIG. 9B, it is understood that the current density of the copper wire on the surface of the lead wire is denser than that of the copper-coating nichrome wire, at 2 MHz, and thus the current density distribution in the copper wire is deviated larger than that in the copper-coating nichrome wire.

In FIG. 9C, it is understood that the current density distribution of the copper-nichrome wire is approximate to the current density distribution of the copper wire at 10 MHz.

It is understood that deviation of the eddy current in the copper wire is larger than deviation of the eddy current in the copper-coating nichrome wire in a frequency region including 2 MHz, and thus the loss in the copper-nichrome wire is smaller than the loss in the copper wire, based on the results.

As described above, in the two-layer structure conductor in which the outer layer is formed from copper and the inner layer is configured by a material having lower conductivity than copper (material having high volume resistivity), it is possible to suppress an increase of eddy current loss in a specific frequency region, in comparison to that of the copper wire.

### Examples 6 to 8

In a copper-coating aluminium wire (Example 6), a copper-coating steel wire (Example 7), and a copper-coating nichrome wire (Example 8) which were two-layer structure conductors having an outer diameter of 0.1 mm, 1.0 mm, or 3.2 mm, a frequency region in which the resistance Rₛ was smaller than the resistance Rₛ of the copper wire was obtained by simulation.

The cross-sectional area ratio of the outer layer was set to 5%, 15%, 25%, and 50%.

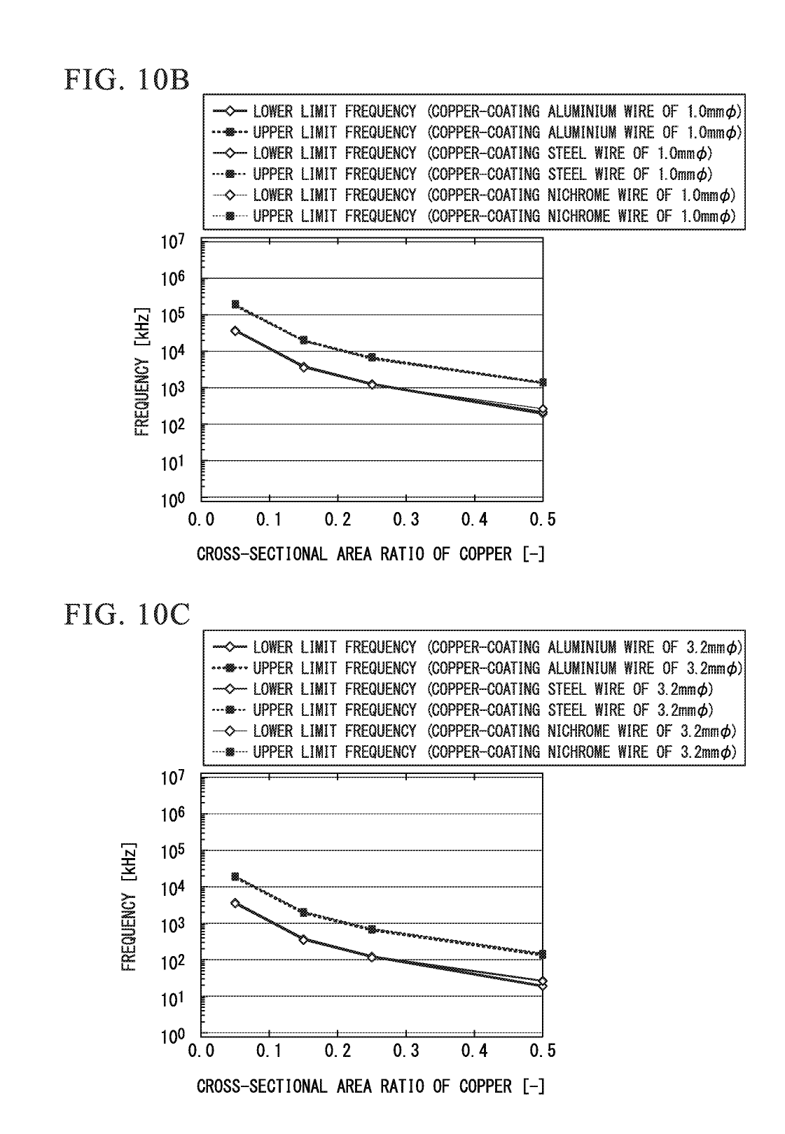

FIGS. 10A to 10C illustrate the lower limit value and the upper limit value of the obtained frequency region.

FIGS. 10A to 10C respectively illustrate results of cases where the outer diameter is 0.1 mm, 1.0 mm, and 3.2 mm.

As illustrated in FIGS. 10A to 10C, if the cross-sectional area ratio of the outer layer (copper) is changed, the frequency region in which Rₛ of the two-layer structure conductor is smaller than Rₛ of the copper wire is changed. For this reason, it is possible to reduce the resistance of the two-layer structure conductor in comparison to that of the copper wire in a wide frequency region by adjusting the cross-sectional area ratio of the outer layer (copper). Accordingly, it is possible to improve the Q value of a coil.

In the copper-coating aluminium wire (Example 6), the copper-coating steel wire (Example 7), and the copper-coating nichrome wire (Example 8), a frequency region in which the resistance Rₛ was smaller than the resistance Rₛ of the copper wire and Dₚ was smaller than Dₚ of the copper wire was obtained by simulation.

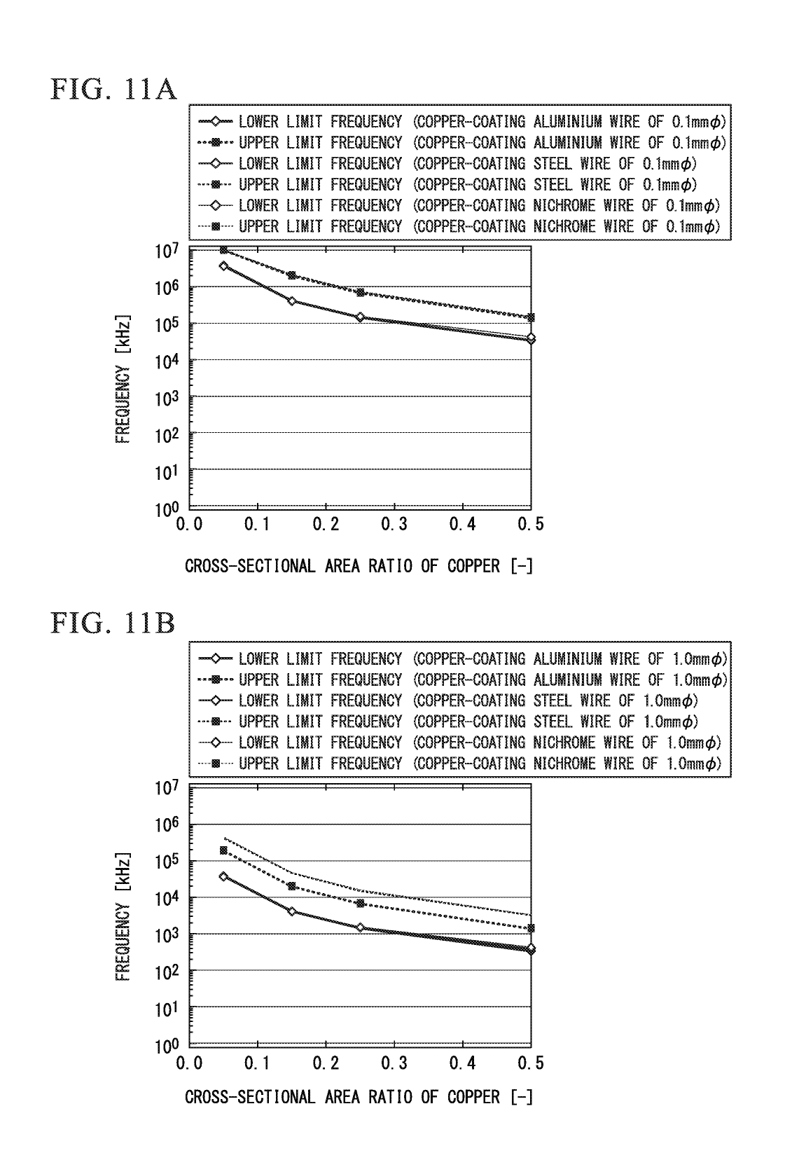

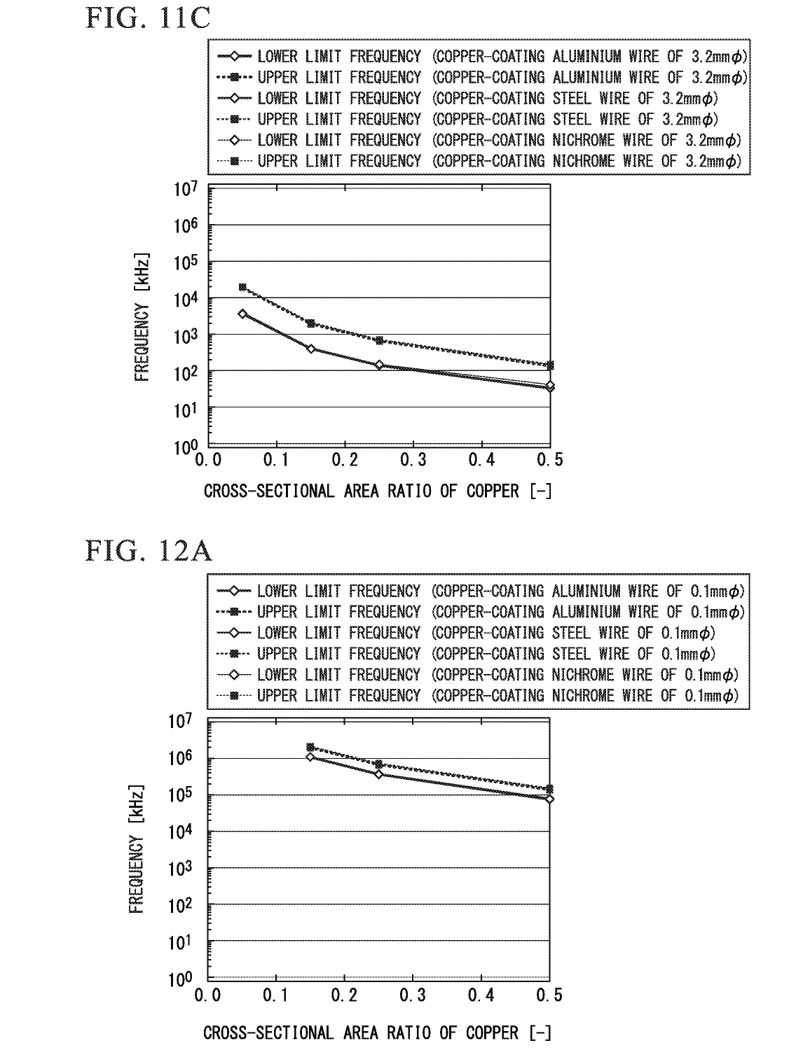

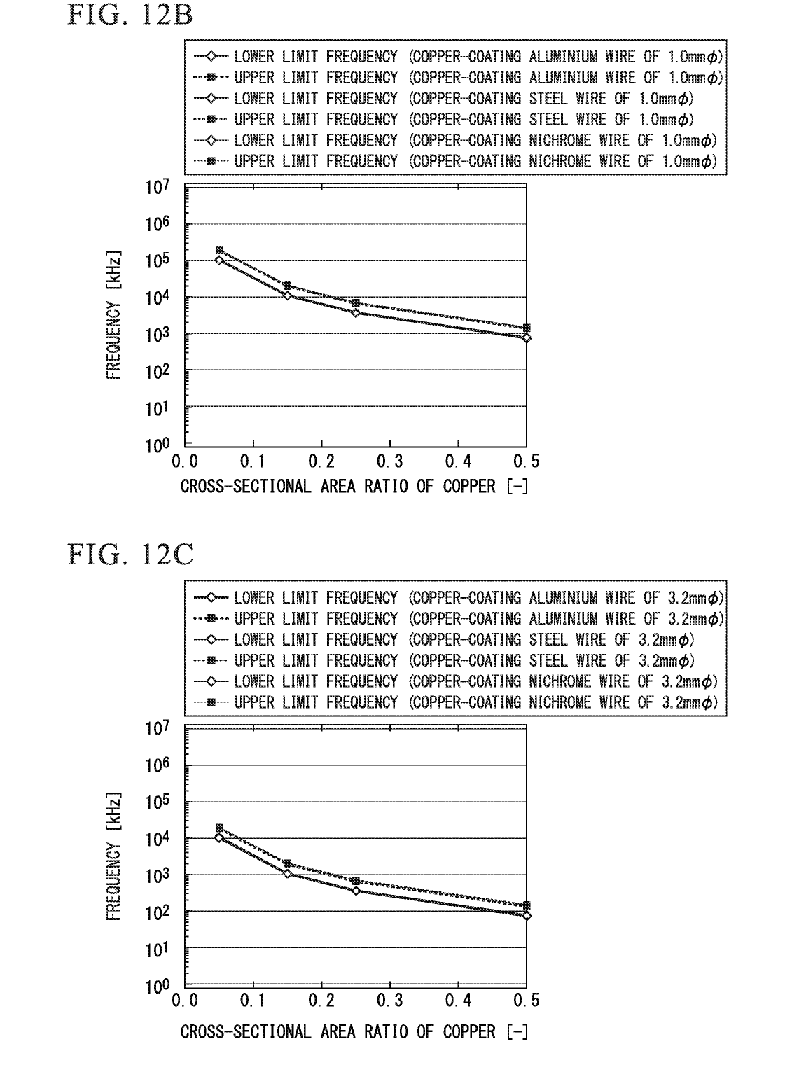

FIGS. 11A to 11C illustrate the lower limit value and the upper limit value of the obtained frequency region.

FIGS. 11A to 11C respectively illustrate results of cases where the outer diameter is 0.1 mm, 1.0 mm, and 3.2 mm.

As illustrated in FIGS. 11A to 11C, if the cross-sectional area ratio of the outer layer (copper) is changed, the frequency region in which the resistance Rₛ of the two-layer structure conductor is smaller than the resistance Rₛ of the copper wire and Dₚ of the two-layer structure conductor is smaller than Dₚ of the copper wire is changed. For this reason, it is possible to reduce the resistance and the proximity effect of the two-layer structure conductor in comparison to those of the copper wire in a wide frequency region by adjusting the cross-sectional area ratio of the outer layer (copper). Accordingly, it is possible to improve the Q value of a coil.

In the copper-coating aluminium wire (Example 6), the copper-coating steel wire (Example 7), and the copper-coating nichrome wire (Example 8), a frequency region in which Rₛ was smaller than Rₛ of the copper wire and Dₚ was smaller than Dₚ of the copper wire, but the internal inductance Lᵢ was larger than the internal inductance Lᵢ of the copper wire was obtained by simulation.

FIGS. 12A to 12C illustrate the lower limit value and the upper limit value of the obtained frequency region.

FIGS. 12A to 12C respectively illustrate results of cases where the outer diameter is 0.1 mm, 1.0 mm, and 3.2 mm.

As illustrated in FIGS. 12A to 12C, if the cross-sectional area ratio of the outer layer (copper) is changed, the frequency region in which Rₛ is smaller than Rₛ of the copper wire and Dₚ is smaller than Dₚ of the copper wire, but Lᵢ is larger than Lᵢ of the copper wire is changed.

For this reason, it is possible to reduce the resistance and the proximity effect of the two-layer structure conductor and to increase the internal inductance of the two-layer structure conductor, in comparison to those of the copper wire in a wide frequency region by adjusting the cross-sectional area ratio of the outer layer (copper).

Accordingly, it is possible to improve the Q value of a coil.

Table 1 to Table 3 show (1) the lower limit value and the upper limit value of a frequency region in which the resistance Rₛ is smaller than the resistance Rₛ of the copper wire, (2) the lower limit value and the upper limit value of a frequency region in which Rₛ is smaller than Rₛ of the copper wire and Dₚ is smaller than Dₚ of the copper wire, and (3) the lower limit value and the upper limit value of a frequency region in which Rₛ is smaller than Rₛ of the copper wire and Dₚ is smaller than Dₚ of the copper wire, but the internal inductance Lᵢ is larger than the internal inductance Lᵢ of the copper wire, regarding the copper-coating aluminium wire (Example 6), the copper-coating steel wire (Example 7), and the copper-coating nichrome wire (Example 8).

TABLE 1

| | | Wire diameter | | | | | |
|---|---|---|---|---|---|---|---|
| | | 0.1 mmφ | | | | | |
| | | Wire type | | | | | |
| | | Copper-coating | | Copper-coating | | Copper-coating | |
| | | aluminium wire | | steel wire | | nichrome wire | |
| | | Lower | Upper | Lower | Upper | Lower | Upper |
| | | limit | limit | limit | limit | limit | limit |
| | Cover- | fre- | fre- | fre- | fre- | fre- | fre- |
| | age of | quency | quency | quency | quency | quency | quency |
| | copper | [kHz] | [kHz] | [kHz] | [kHz] | [kHz] | [kHz] |
| Only Rₛ | 0.5 | 19600 | 137000 | 27300 | 152000 | 26500 | 148000 |
| | 0.25 | 126000 | 665000 | 127000 | 724000 | 119000 | 712000 |
| | 0.15 | 385000 | 1960000 | 375000 | 2130000 | 355000 | 2110000 |
| | 0.05 | 3740000 | 20500000 | 3560000 | 20600000 | 3550000 | 20500000 |
| Rₛ and Dₚ | 0.5 | 33600 | 137000 | 35000 | 152000 | 42400 | 148000 |
| | 0.25 | 143000 | 665000 | 142000 | 724000 | 153000 | 712000 |
| | 0.15 | 411000 | 1960000 | 402000 | 2130000 | 407000 | 2110000 |
| | 0.05 | 3820000 | 20500000 | 3640000 | 20600000 | 3640000 | 20500000 |
| Rₛ, Dₚ, | 0.5 | 75200 | 137000 | 79700 | 152000 | 77700 | 148000 |
| and Lᵢ | 0.25 | 369000 | 665000 | 377000 | 724000 | 364000 | 712000 |
| | 0.15 | 1090000 | 1960000 | 1100000 | 2130000 | 1090000 | 2110000 |
| | 0.05 | 10600000 | 20500000 | 10600000 | 20600000 | 10600000 | 20500000 |

| | | Wire diameter | | | | | |
|---|---|---|---|---|---|---|---|
| | | 0.4 mmφ | | | | | |
| | | Wire type | | | | | |
| | | Copper-coating | | Copper-coating | | Copper-coating | |
| | | aluminium wire | | steel wire | | nichrome wire | |
| | | Lower | Upper | Lower | Upper | Lower | Upper |
| | | limit | limit | limit | limit | limit | limit |
| | Cover- | fre- | fre- | fre- | fre- | fre- | fre- |
| | age of | quency | quency | quency | quency | quency | quency |
| | copper | [kHz] | [kHz] | [kHz] | [kHz] | [kHz] | [kHz] |
| Only Rₛ | 0.5 | 1220 | 8590 | 1700 | 9500 | 1650 | 9290 |
| | 0.25 | 7970 | 41600 | 8000 | 45200 | 7510 | 44500 |
| | 0.15 | 24000 | 123000 | 23400 | 133000 | 22100 | 132000 |
| | 0.05 | 233000 | 1280000 | 222000 | 1280000 | 221000 | 1280000 |
| Rₛ and Dₚ | 0.5 | 2100 | 8590 | 2180 | 9500 | 2650 | 9290 |
| | 0.25 | 8990 | 41600 | 8980 | 45200 | 9630 | 44500 |
| | 0.15 | 25600 | 123000 | 25100 | 133000 | 25400 | 132000 |
| | 0.05 | 238000 | 1280000 | 227000 | 1280000 | 227000 | 1280000 |
| Rₛ, Dₚ, | 0.5 | 4700 | 8590 | 4980 | 9500 | 4850 | 9290 |
| and Lᵢ | 0.25 | 23000 | 41600 | 23500 | 45200 | 22700 | 44500 |
| | 0.15 | 68700 | 123000 | 69500 | 133000 | 68600 | 132000 |
| | 0.05 | 658000 | 1280000 | 660000 | 1280000 | 657000 | 1280000 |

TABLE 2

| | | Wire diameter | | | | | | | | | | | |
|---|---|---|---|---|---|---|---|---|---|---|---|---|---|
| | | 1.0 mmφ | | | | | | 1.8 mmφ | | | | | |
| | | Wire type | | | | | | | | | | | |
| | | Copper-coating | | Copper-coating | | Copper-coating | | Copper-coating | | Copper-coating | | Copper-coating | |
| | | aluminium wire | | steel wire | | nichrome wire | | aluminium wire | | steel wire | | nichrome wire | |
| | | Lower | Upper | Lower | Upper | Lower | Upper | Lower | Upper | Lower | Upper | Lower | Upper |
| | | limit | limit | limit | limit | limit | limit | limit | limit | limit | limit | limit | limit |
| | Cover- | fre- | fre- | fre- | fre- | fre- | fre- | fre- | fre- | fre- | fre- | fre- | fre- |
| | age of | quency | quency | quency | quency | quency | quency | quency | quency | quency | quency | quency | quency |
| | copper | [kHz] | [kHz] | [kHz] | [kHz] | [kHz] | [kHz] | [kHz] | [kHz] | [kHz] | [kHz] | [kHz] | [kHz] |
| Only Rₛ | 0.5 | 196 | 1380 | 216 | 1450 | 265 | 1480 | 60.8 | 424 | 84.4 | 469 | 82 | 459 |
| | 0.25 | 1260 | 6660 | 1260 | 6650 | 1190 | 7120 | 393 | 2050 | 394 | 2230 | 370 | 2190 |
| | 0.15 | 3850 | 19700 | 3740 | 20800 | 3550 | 21100 | 1180 | 6070 | 1150 | 6580 | 1090 | 6530 |
| | 0.05 | 37400 | 188000 | 37400 | 187000 | 35500 | 201000 | 11500 | 57900 | 11100 | 62300 | 10900 | 62300 |
| Rₛ and Dₚ | 0.5 | 336 | 1380 | 385 | 1450 | 424 | 1480 | 103 | 424 | 107 | 469 | 130 | 459 |
| | 0.25 | 1430 | 6660 | 1430 | 6650 | 1530 | 7120 | 443 | 2050 | 443 | 2230 | 475 | 2190 |
| | 0.15 | 4110 | 19700 | 4020 | 20800 | 4070 | 21100 | 1260 | 6070 | 1230 | 6580 | 1240 | 6530 |
| | 0.05 | 38200 | 188000 | 38200 | 187000 | 36400 | 201000 | 11700 | 57900 | 11300 | 62300 | 11100 | 62300 |
| Rₛ, Dₚ, | 0.5 | 752 | 1380 | 726 | 1450 | 777 | 1480 | 231 | 424 | 245 | 469 | 239 | 459 |
| and Lᵢ | 0.25 | 3690 | 6660 | 3690 | 6650 | 3640 | 7120 | 1130 | 2050 | 1150 | 2230 | 1110 | 2190 |
| | 0.15 | 10900 | 19700 | 10800 | 20800 | 10900 | 21100 | 3390 | 6070 | 3420 | 6580 | 3380 | 6530 |
| | 0.05 | 104000 | 188000 | 104000 | 187000 | 104000 | 201000 | 32400 | 57900 | 34500 | 62300 | 32400 | 62300 |

TABLE 3

| | | Wire diameter | | | | | | | | | | | |
|---|---|---|---|---|---|---|---|---|---|---|---|---|---|
| | | 2.5 mmφ | | | | | | 3.2 mmφ | | | | | |
| | | Wire type | | | | | | | | | | | |
| | | Copper-coating | | Copper-coating | | Copper-coating | | Copper-coating | | Copper-coating | | Copper-coating | |
| | | aluminium wire | | steel wire | | nichrome wire | | aluminium wire | | steel wire | | nichrome wire | |
| | | Lower | Upper | Lower | Upper | Lower | Upper | Lower | Upper | Lower | Upper | Lower | Upper |
| | | limit | limit | limit | limit | limit | limit | limit | limit | limit | limit | limit | limit |
| | Cover- | fre- | fre- | fre- | fre- | fre- | fre- | fre- | fre- | fre- | fre- | fre- | fre- |
| | age of | quency | quency | quency | quency | quency | quency | quency | quency | quency | quency | quency | quency |
| | copper | \|kHz\| | \|kHz\| | \|kHz\| | \|kHz\| | \|kHz\| | \|kHz\| | \|kHz\| | \|kHz\| | \|kHz\| | \|kHz\| | \|kHz\| | \|kHz\| |
| Only Rₛ | 0.5 | 31.4 | 220 | 43.7 | 243 | 42.4 | 237 | 19.1 | 134 | 26.6 | 148 | 25.8 | 145 |
| | 0.25 | 203 | 1060 | 204 | 1150 | 191 | 1140 | 123 | 650 | 124 | 707 | 116 | 696 |
| | 0.15 | 618 | 3150 | 601 | 3410 | 569 | 3380 | 376 | 1920 | 366 | 2080 | 347 | 2060 |
| | 0.05 | 6000 | 30000 | 5710 | 32300 | 5690 | 32300 | 3660 | 18300 | 3480 | 19700 | 3470 | 19700 |
| Rₛ and Dₚ | 0.5 | 53.9 | 220 | 56.1 | 243 | 68 | 237 | 32.8 | 134 | 34.2 | 148 | 41.4 | 145 |
| | 0.25 | 229 | 1060 | 229 | 1150 | 245 | 1140 | 139 | 650 | 139 | 707 | 149 | 696 |
| | 0.15 | 659 | 3150 | 644 | 3410 | 652 | 3380 | 402 | 1920 | 392 | 2080 | 397 | 2060 |
| | 0.05 | 6120 | 30000 | 5830 | 32300 | 5830 | 32300 | 3730 | 18300 | 3560 | 19700 | 3550 | 19700 |
| Rₛ, Dₚ, | 0.5 | 119 | 220 | 126 | 243 | 123 | 237 | 73.5 | 134 | 77.8 | 148 | 75.9 | 145 |
| and Lᵢ | 0.25 | 592 | 1060 | 604 | 1150 | 583 | 1140 | 361 | 650 | 368 | 707 | 355 | 696 |
| | 0.15 | 1750 | 3150 | 1770 | 3410 | 1750 | 3380 | 1060 | 1920 | 1070 | 2080 | 1060 | 2060 |
| | 0.05 | 16700 | 30000 | 16800 | 32300 | 16700 | 32300 | 10200 | 18300 | 11000 | 19700 | 10100 | 19700 |

The reason that Rₛ, Dₚ, and Lᵢ of the two-layer structure conductor are different from Rₛ, Dₚ, and Lᵢ of the copper wire is because flowing of the current into the inner layer having low conductivity is difficult, and thus the current distribution by the skin effect is different between the two-layer structure conductor and the copper wire.

The lower limit frequency and the upper limit frequency of the above-described frequency region may be determined in association with the skin thickness δ [m] in a copper wire which functions as a reference.

The “copper wire which functions as a reference” includes a conductor portion formed from pure copper (formed only by pure copper). It is preferable that the copper wire have a wire diameter the same as that of the two-layer structure conductor. However, the copper wire may have a different wire diameter.

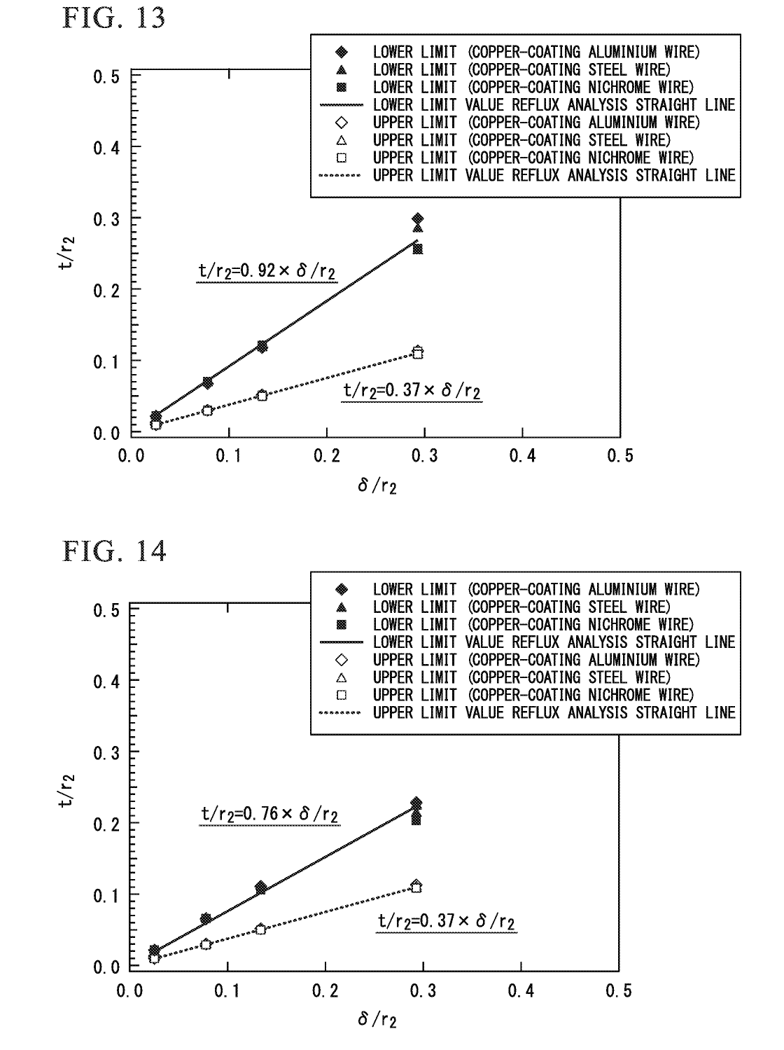

FIG. 13 illustrates a correlation between a ratio of the skin thickness δ of the copper wire and the radius r₂ of the two-layer structure conductor, and a ratio of the thickness t of the outer layer (copper) in the two-layer structure conductor and the radius r₂ of the two-layer structure conductor, at the lower limit frequency and the upper limit frequency of a frequency region in which Rₛ of the two-layer structure conductor is smaller than Rₛ of the copper wire.

Regression analysis was performed on the results by using a linear function, thereby a regression analysis straight line illustrated in FIG. 13 was obtained. The solid line indicates a regression analysis straight line for the lower limit frequency, and the broken line indicates a regression analysis straight line of the upper limit frequency.

The skin thickness δ [m] of the copper wire is represented by the following Expression (18).

δ=√(2/ωσμ) (18)

(ω: angular frequency (=2πf) of current, μ: magnetic permeability [H/m] of copper wire, σ: conductivity [Ω⁻¹m⁻¹] of copper wire, f: frequency [Hz])

In a case of the lower limit frequency, the thickness t of the outer layer (copper) in the two-layer structure conductor was 0.92 times the skin thickness δ of the copper wire. In a case of the upper limit frequency, the thickness t was 0.37 times the skin thickness δ.

For this reason, when the thickness t [m] of the outer layer (copper) is in a range of the following Expression (19), Rₛ of the two-layer structure conductor is smaller than Rₛ of the copper wire. Accordingly, it is possible to improve the Q value of a coil.

1.1δ<t<2.7δ (19)

With the Expression (18), if the conductivity of copper is set to 5.8×10⁷ [Ω⁻¹·m⁻¹], and the magnetic permeability of copper is set to 4π×10⁻⁷ [H/m], which is equal to the magnetic permeability of a vacuum, t [m] given in Expression (19) is represented as in the following Expression (20) as a relational expression depending on a frequency f [Hz].

86×10⁻³×f^{-0.5}<t<178×10⁻³×f^{-0.5} (20)

FIG. 14 illustrates a correlation between a ratio of the skin thickness δ of the copper wire and the radius r₂ of the two-layer structure conductor, and a ratio of the thickness t of the outer layer (copper) in the two-layer structure conductor and the radius r₂ of the two-layer structure conductor, at the lower limit frequency and the upper limit frequency of a frequency region in which Rₛ of the two-layer structure conductor is smaller than Rₛ of the copper wire, and Dₚ of the two-layer structure conductor is smaller than Dₚ of the copper wire.

Regression analysis was performed on the results by using a linear function, thereby a regression analysis straight line illustrated in FIG. 14 was obtained. The solid line indicates a regression analysis straight line for the lower limit frequency, and the broken line indicates a regression analysis straight line of the upper limit frequency.

In a case of the lower limit frequency, the thickness t of the outer layer (copper) in the two-layer structure conductor was 0.76 times the skin thickness δ of the copper wire. In a case of the upper limit frequency, the thickness t was 0.37 times the skin thickness δ.

For this reason, when the thickness t [m] of the outer layer (copper) is in a range of the following Expression (21), Rₛ of the two-layer structure conductor is smaller than Rₛ of the copper wire and Dₚ is smaller than Dₚ of the copper wire. Accordingly, it is possible to improve the Q value of a coil.

1.3δ<t<2.7δ (21)

With the Expression (18), if the conductivity of copper is set to 5.8×10⁷ [Ω⁻¹·m⁻¹], and the magnetic permeability of copper is set to 4π×10⁻⁷ [H/m], which is equal to the magnetic permeability of a vacuum, t [m] given in Expression (21) is represented as in the following Expression (22) as a relational expression depending on a frequency f [Hz].

86×10⁻³×f^{-0.5}<t<178×10⁻³×f^{-0.5} (22)

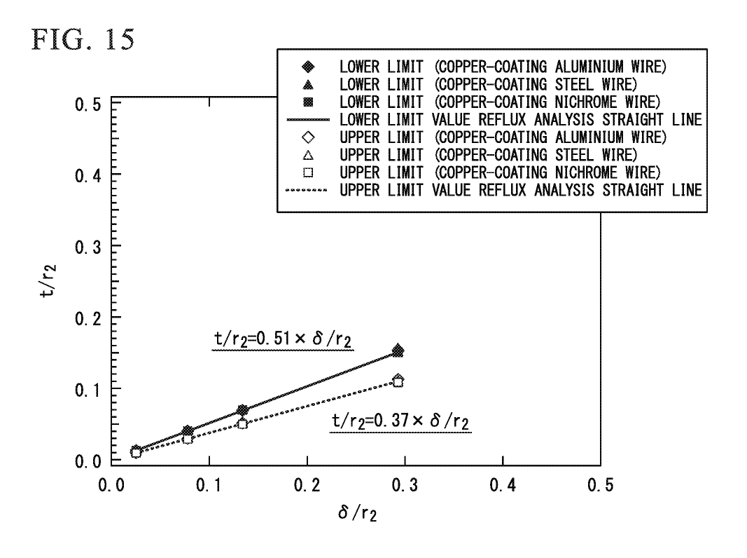

FIG. 15 illustrates a correlation between a ratio of the skin thickness δ of the copper wire and the radius r₂ of the two-layer structure conductor, and a ratio of the thickness t of the outer layer (copper) in the two-layer structure conductor and the radius r₂ of the two-layer structure conductor, at the lower limit frequency and the upper limit frequency of a frequency region in which Rₛ of the two-layer structure conductor is smaller than Rₛ of the copper wire, and Dₚ of the two-layer structure conductor is smaller than Dₚ of the copper wire, but Lᵢ is larger than Lᵢ of the copper wire.

Regression analysis was performed on the results by using a linear function, thereby a regression analysis straight line illustrated in FIG. 15 was obtained. The solid line indicates a regression analysis straight line for the lower limit frequency, and the broken line indicates a regression analysis straight line of the upper limit frequency.

In a case of the lower limit frequency, the thickness t of the outer layer (copper) in the two-layer structure conductor was 0.51 times the skin thickness δ of the copper wire. In a case of the upper limit frequency, the thickness t was 0.37 times the skin thickness δ.

For this reason, when the thickness t [m] of the outer layer (copper) is in a range of the following Expression (23), Rₛ of the two-layer structure conductor is smaller than Rₛ of the copper wire and Dₚ is smaller than Dₚ of the copper wire, but Lᵢ is larger than Lᵢ of the copper wire. Accordingly, it is possible to improve the Q value of a coil.

2.0δ<t<2.7δ (23)

With the Expression (18), if the conductivity of copper is set to 5.8×10⁷ [Ω⁻¹·m⁻¹], and the magnetic permeability of copper is set to 4π×10⁻⁷ [H/m], which is equal to the magnetic permeability of a vacuum, t [m] given in Expression (23) is represented as in the following Expression (24) as a relational expression depending on a frequency f [Hz].

132×10⁻³×f^{-0.5}<t<178×10⁻³×f^{-0.5} (24)

Generally, the frequency of a current flowing in a cable or a coil is determined by an external factor of equipment using the current, and the like. Examples of equipment to be used include an induction heating device, a non-contact feeding device, a plasma-generating device, a switching power source, a microwave filter, an antenna, and facilities attached to the above-described device.

When the frequency is determined, the thickness of the lead wire is determined by a factor relating to the size, balance between Rₛ and Dₚ, or the like. If the frequency and the thickness of the lead wire are determined, the thickness and the cross-sectional area ratio of the outer layer (copper) are selected in accordance with Expression (19), and thus it is possible to reduce resistance in comparison to that of the copper wire.

In a case where ignoring of an influence of the proximity effect is not possible, the thickness and the cross-sectional area ratio of the outer layer (copper) are selected in accordance with Expression (21), and thus it is possible to reduce both of the resistance and the proximity effect in comparison to that of the copper wire.

In a case where the Q value of a coil is increased, the thickness and the cross-sectional area ratio of the outer layer (copper) are selected in accordance with Expression (23), and thus it is possible to increase apparent electric power with respect to the electricity consumption of the coil.

The wire of the present invention may have a structure in which the outer layer is formed from copper, and the inner layer is formed from a material having lower conductivity than that of copper (that is, material having high volume resistivity. For example, metal or an insulating body having lower conductivity than that of copper). The material for forming the inner layer is not limited the exemplified materials.

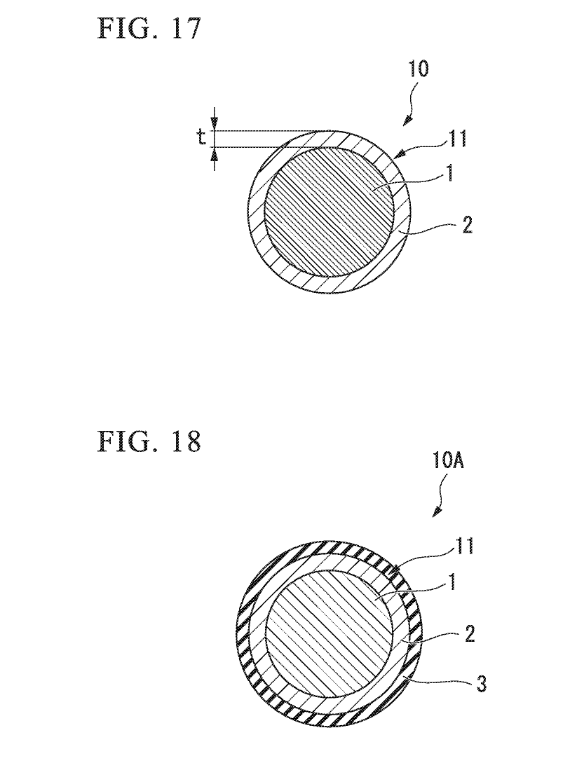

FIG. 18 illustrates a wire 10A which is a modification example of the wire 10. In the wire 10A, an insulation coating layer 3 is provided on an outer circumferential surface of a conductor portion 11 (on an outer circumferential surface of an outer layer 2). The insulation coating layer 3 coats the outer circumferential surface of the conductor portion 11. The insulation coating layer 3 is the outermost layer of the wire 10A.

The insulation coating layer 3 may be formed by coating with an enamel coating material such as polyester, polyurethane, polyimide, polyester imide, polyamide-imide, and the like. The wire 10A in which the insulation coating layer 3 is formed by using the enamel coating material is an enamel wire.

(Litz Wire)

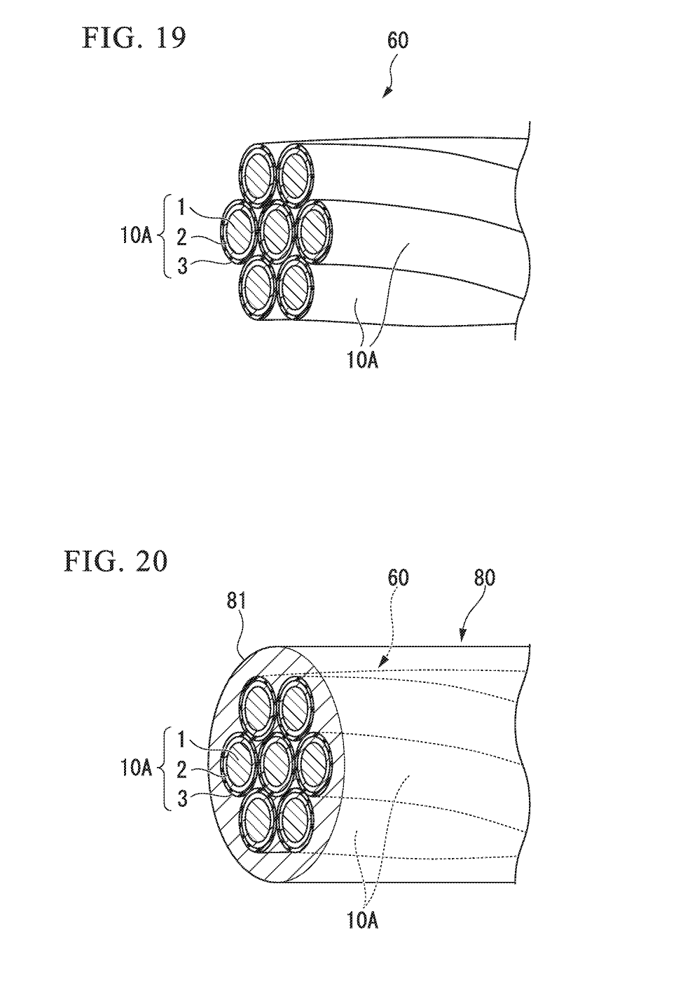

FIG. 19 illustrates a litz wire 60 which is an example of a litz wire which uses the wire 10A illustrated in FIG. 18. The litz wire 60 is configured to have a plurality of wires 10A which are bundled and twisted.

(Cable)

FIG. 20 illustrates a cable 80 which is an example of a cable in which insulation coating is performed on the litz wire 60. In the cable 80, an insulation coating layer 81 formed of polyethylene and the like is provided on an outer circumferential surface of the litz wire 60.

(High-Frequency Coil)

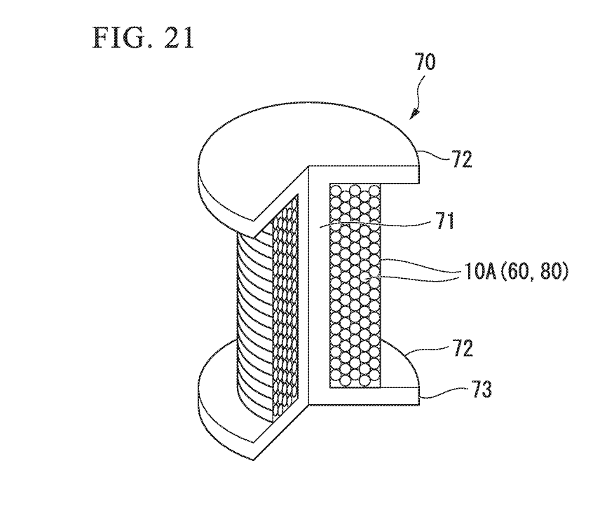

FIG. 21 illustrates a coil 70 which is an example of a coil (high-frequency coil) which uses the wire 10A illustrated in FIG. 18. The coil 70 includes the wire 10A and a support body 73. The support body 73 includes a body portion 71 and flange portions 72 which are formed at both ends of the body portion 71.

The wire 10A is wound around the body portion 71.

The coil 70 may use the litz wire 60 illustrated in FIG. 19, instead of the wire 10A or the cable 80 may be used as the coil 70.

### Example 9

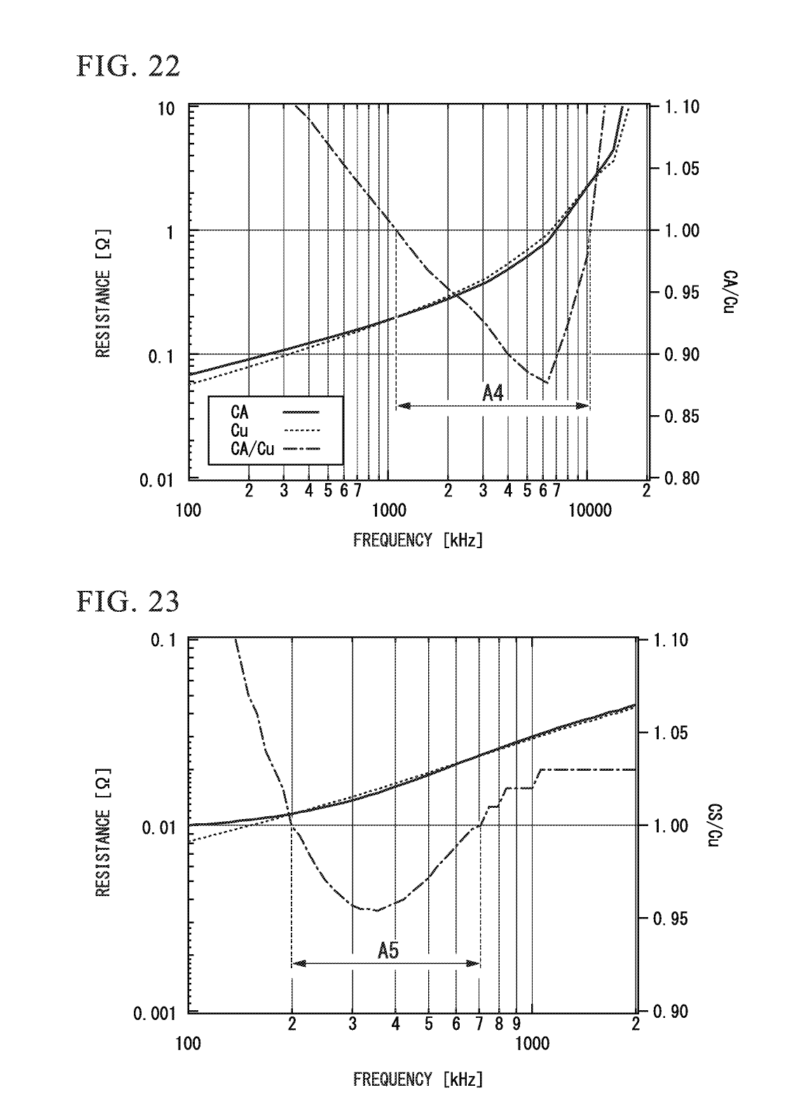

A coil (number of winding of 3) was manufactured by using a copper-coating aluminium wire (cross-sectional area ratio of outer layer: 25%, outer diameter: 1.8 mm), and AC resistance was measured. FIG. 22 illustrates a result.

For comparison, similar calculation was performed on a copper wire having a single-layer structure (Comparative Example 2).

In FIG. 22, the copper-coating aluminium wire was marked as “CA” and the copper wire was marked as “Cu”. The ratio (copper-coating aluminium wire/copper wire) of Rₛ was set as “CA/Cu”.

As illustrated in FIG. 22, in a frequency region A4, Rₛ in Example 9 (copper-coating aluminium wire) was less than Rₛ in Comparative Example 2 (copper wire), and the ratio (copper-coating aluminium wire/copper wire) (CA/Cu) of Rₛ was smaller than 1.

### Example 10

A coil (number of winding of 1) was manufactured by using a copper-coating steel wire (cross-sectional area ratio of outer layer: 25%, outer diameter: 2.0 mm), and AC resistance was measured. FIG. 23 illustrates a result.

In FIG. 23, the copper-coating steel wire was marked as “CS” and the copper wire was marked as “Cu”. The ratio (copper-coating steel wire/copper wire) of Rₛ was set as “CS/Cu”.

As illustrated in FIG. 23, in a frequency region A5, Rₛ in Example 10 (copper-coating steel wire) was less than Rₛ in Comparative Example 2 (copper wire), and the ratio of Rₛ was smaller than 1.

<Manufacturing Method of High-Frequency Wire>

Subsequently, an example of a method of manufacturing the wire 10 will be described.

A copper tape is vertically attached to a surface of an inner layer body formed from aluminium alloys, steel, nichrome alloys, and the like, for example. A result of attachment is subjected to TIG welding, plasma welding, or the like. Thus, an outer layer formed from copper is formed on an outer circumferential surface of the inner layer body, and a material obtained by the formation is set as a base material. The base material is subjected to wire drawing through a wire drawing die having a plurality of stages, and thus the wire 10 which includes the inner layer 1 and the outer layer 2 may be obtained.

The base material obtained by inserting the inner layer body formed by aluminium alloys and the like into a copper tube is subjected to wire drawing through a wire drawing die having a plurality of stages, and thus the wire 10 which includes the inner layer 1 and the outer layer 2 may be obtained. The copper tube is manufactured by using a general tube manufacturing method.

The outer layer 2 may be formed on an outer circumferential surface of the inner layer 1 by copper plating.

The manufacturing method described herein does not limit the scope of the present invention. The high-frequency wire according to the embodiment of the present invention can also be manufactured by a manufacturing method other than the method exemplified herein.

The above-described embodiments have exemplified a device and a method in order to materialize the technical ideas of the invention. Therefore, in the technical ideas of the invention, the material properties, the shapes, the structures, the arrangements, and the like of the configurational components are not specified. The present invention does not exclude a structure in which a third layer is included in addition to the inner layer and the outer layer. As the regression analysis by using the above-described linear function, a least squares method may be employed.

### INDUSTRIAL APPLICABILITY

A high-frequency wire and a high-frequency coil of the present invention can be utilized in the electronic equipment industry including the industry of manufacturing various devices such as a non-contact feeding device, a high-frequency current generation device, and the like including a high-frequency transformer, a motor, a reactor, a choke coil, an induction heating device, a magnetic head, a high-frequency feeding cable, a DC power unit, a switching power source, an AC adapter, eddy current detection-type displacement sensor•flaw sensor, an IH cooking heater, a coil, a feeding cable, and the like.

### DESCRIPTION OF THE REFERENCE SYMBOLS

1 INNER LAYER, 2 OUTER LAYER, 10 HIGH-FREQUENCY WIRE (WIRE), 11 CONDUCTOR PORTION, 60 LITZ WIRE, 70 HIGH-FREQUENCY COIL

1. A high-frequency wire comprising:
a conductor portion which comprises an inner layer formed of a material having lower conductivity than copper, and an outer layer which coats the inner layer and is formed of copper, wherein
in a frequency range of an AC current for using the high-frequency wire, in a case where a skin thickness δ [m] of a copper wire including a conductor portion formed of pure copper is defined as δ=√(2/ωσμ), a thickness t [m] of the outer layer satisfies 1.1δ<t<2.7δ,
here ω indicates an angular frequency of a current, which is represented by 2πf, μ indicates magnetic permeability [H/m] of the copper wire, σ indicates conductivity [Ω⁻¹m⁻¹] of copper, and f indicates a frequency [Hz].

2. The high-frequency wire according to claim 1, wherein
the thickness t of the outer layer satisfies 1.3δ<t<2.7δ.

3. The high-frequency wire according to claim 1, wherein
the thickness t of the outer layer satisfies 2.0δ<t<2.7δ.

4. The high-frequency wire according to claim 1, wherein
an insulation coating layer is provided on an outer circumferential surface of the conductor portion.

5. A high-frequency coil comprising:
the high-frequency wire according to claim 4.

6. A litz wire comprising:
a plurality of the twisted high-frequency wires according to claim 4.

7. A cable comprising:
the litz wire according to claim 6, which is subjected to insulation coating.

8. A coil comprising:
the litz wire according to claim 6.
